(19) United States
(12) Patent Application Publication
(10) Pub. No.: US 2025/0278517 A1
(43) Pub. Date: Sep. 4, 2025

(54) Technologies for Blockchain-Based Secure Data Access, Authentication and Exchange

(71) Applicant: K1X, Inc., Morristown, NJ (US)

(72) Inventors: Geralyn R. Hurd, Chicago, IL (US); Neal R. Schneider, Fishers, IN (US)

(21) Appl. No.: 19/208,764

(22) Filed: May 15, 2025

Related U.S. Application Data
(63) Continuation-in-part of application No. 17/889,549, filed on Aug. 17, 2022, now abandoned.
(60) Provisional application No. 63/233,962, filed on Aug. 17, 2021.
(60) Provisional application No. 63/271,467, filed on Oct. 25, 2021.

(51) Int. Cl. G06F 21/62; G06F 21/60; H04L 9/32

(52) U.S. Cl. CPC G06F 21/6245; G06F 21/602; H04L 9/3221

(57) ABSTRACT

Technologies for secure document exchange by a producing party and a receiving party. The system and method facilitates the exchange of confidential documents between the producing party and a receiving party while ensuring robust security, permission control, and auditability. The system leverages blockchain technology, smart contracts, and zero-knowledge proof (ZKP) authentication to manage document access and verify identities without exposing confidential information.

### RELATED APPLICATIONS

This application is a continuation-in-part of U.S. patent application Ser. No. 17/889,549 filed Aug. 17, 2022 for a “Method and System for Digital Tax Document Exchange,” which claimed the benefit of U.S. Provisional Application No. 63/271,467, filed Oct. 25, 2021 for a “Method and System for Digital Tax Document Exchange” and U.S. Provisional Application No. 63/233,962, filed Aug. 17, 2021 for a “K-1 Exchange.” These applications are each hereby incorporated by reference in their entireties.

### BACKGROUND

Each year in the United States, roughly 40 million Schedules K1 are distributed from about 7.5 M million flow-through entities. Flow-through entities include Partnerships, S Corporations and Trusts. A Schedule K1 comprises a 1-page IRS form, which is often called a “face page,” and frequently more than 50 pages of free-form, whitepaper statements that describe the federal, state and international income tax filing requirements of a partner. FIG. 1 shows an example, blank K1 face page, which contains the majority of the structured information. Each of the highlighted boxes (Part I, Boxes A-D, Part II, Boxes E-M, and Part III, Boxes 1-20) in FIG. 1 follow a structured format. However, one complexity is that some highlighted boxes can have too much detail to fit on this face page, so the remaining information exists in the unstructured, whitepaper sections of the document. In addition, the face page of the K-1 only addresses federal income tax. Whitepaper statements and other state tax forms will be included in K-1 packets to provide state and international filing responsibilities.

FIG. 2A shows an example in which Box 16 of a K1 face page is filled with foreign transactions A-F, along with a note of “STMT.” The note “STMT” means that foreign transaction information on the face page is incomplete, and thus, a user would need to find the corresponding section in the whitepapers to get the remaining details regarding Box 16 (foreign transactions). FIG. 2B shows an example portion of a whitepaper corresponding to Box 16 (foreign transactions) filling in details for remaining foreign transactions G-M.

Pursuant to Section 6031(b), partnerships are required to furnish to its partners information as is necessary to enable each partner to compute its distributive share of partnership income or loss from such trade or business. But because there is no standardization of Schedule K1 packets, each of the 7.5M schedule K-1 packets is unique. There is no standard schema that can be followed to provide all federal, state and international data to a partner and there is no standard data request (from the partnership) where a partner invested in multiple (sometimes hundreds) can respond once and have that data transmitted to all appropriate partnership entities. Current processing for these types of documents involves a human reviewing the Schedule K1 packet, typically in PDF form, and hand-typing information into their processing software.

There have been a number of OCR scanning technologies introduced that have tried to tackle this problem but they do not work. The submitter of this patent application also has a pending patent application, U.S. Pre-Grant Publication No. 2021/0082062 filed Sep. 16, 2019 for a “Machine Learning System for Summarizing Tax Documents with Non-Structured Portion,” which is hereby incorporated by reference. AI-powered machine-learning solutions have made great strides towards extracting much of the data provided in a Schedule K-1, but it is not exact and it is often not everything a specific partner needs to meet its filing requirements.

The problem is further exacerbated as a result of the tiered partnership structure. Many schedule K-1 packets received are not just the reporting of a single partnership's activity, but rather a culmination of activities that are aggregated and distributed to various tiers of owners. The result is often a Schedule K-1 packet that may provide the same data element reported multiple times vs. the aggregate reporting for all tiers within one summary.

Therefore, there is a need for a system that overcomes one or more of these issues.

### SUMMARY

According to one aspect, this disclosure is a digital tax data exchange system. The system includes a schema validation subsystem to validate one or more structured data files are formatted in accordance with a universal data schema based on entity-specific data requirements. The plurality of structured data files relate to K-1 producers, which are financial entities that issue schedule K-1 documents and K-1 receivers, which are persons to whom schedule K-1 documents are issued. In response to validating the one or more structured data files, the schema validation subsystem is to generate a validation certificate that is associated with the one or more structured data files. The system includes a registration manager, on one or more processors, to register a plurality of legal entities as a K-1 producer and/or a K-1 receiver as registered users in a database. The registration manager is to perform a digital identity validation process. The system also includes a connections subsystem, on one or more processors, to make connections between one or more K-1 producers and one or more K-1 receivers to establish access control therebetween. The access control between connected K-1 producers and K-1 receivers provides data access to one or more of each other's structured data files.

According to another aspect, this disclosure is a computerized method for digital tax data exchange. The method includes validating one or more structured data files are formatted in accordance with a universal data schema based on entity-specific data requirements. The plurality of structured data files relate to K-1 producers, which are financial entities that issue schedule K-1 documents and K-1 receivers, which are persons to whom schedule K-1 documents are issued. In response to validating the one or more structured data files, the method includes validating includes generating a validation certificate that is associated with the one or more structured data files. The method includes registering a plurality of legal entities as a K-1 producer and/or a K-1 receiver as registered users in a database, wherein the registering step includes a digital identity validation process. The method also includes making connections between one or more K-1 producers and one or more K-1 receivers to establish access control therebetween. The access control between connected K-1 producers and K-1 receivers provides data access to one or more of each other's structured data files.

According to a further aspect, this disclosure is one or more non-transitory, computer-readable storage media comprising a plurality of instructions stored thereon that, in response to being executed, cause a computing device to validate one or more structured data files are formatted in accordance with a universal data schema based on entity-specific data requirements. The plurality of structured data files relate to K-1 producers, which are financial entities that issue schedule K-1 documents and K-1 receivers, which are persons to whom schedule K-1 documents are issued. In response to validating the one or more structured data files, the instructions generates a validation certificate that is associated with the one or more structured data files. There are instructions to register a plurality of legal entities as a K-1 producer and/or a K-1 receiver as registered users in a database, which includes a digital identity validation process. There are also includes to make connections between one or more K-1 producers and one or more K-1 receivers to establish access control therebetween. The access control between connected K-1 producers and K-1 receivers provides data access to one or more of each other's structured data files.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is an example blank K-1 face page;

FIG. 2A is an example detailed view of Box 16 of the K-1 face page of FIG. 1 filled in with certain information;

FIG. 2B is an example portion of a whitepaper corresponding with certain details corresponding to Box 16 shown in FIG. 2A;

FIG. 3 is a simplified block diagram of at least one embodiment of various components and environments of the K-1 exchange;

FIG. 4 is a simplified block diagram of at least one embodiment of an .K-1X document of the K-1 exchange;

FIG. 5 is a simplified block diagram showing example components of the .K-1X document shown in FIG. 4 according to an embodiment of this disclosure;

FIG. 6 is an example XML file representing the data portion of the .K-1X document shown in FIG. 4 according to an embodiment of this disclosure;

FIG. 7 is an example XML file representing the certificate portion of the .K-1X document shown in FIG. 4 according to an embodiment of this disclosure;

FIG. 8 is an example XML schema definition file for the certificate portion of the .K-1X document shown in FIG. 4 according to an embodiment of this disclosure;

FIG. 9 illustrates an example K-1 schema organization according to an embodiment of this disclosure;

FIG. 10 is an example XML schema definition file for the attachments portion of the .K-1X document shown in FIG. 4 according to an embodiment of this disclosure;

FIG. 11 is an example XML schema definition file for the data types portion of the .K-1X document shown in FIG. 4 according to an embodiment of this disclosure;

FIG. 12 illustrates an example K-1 schema organization for an example partnership folder according to an embodiment of this disclosure;

FIG. 13 illustrates an example K-1 schema organization for example data types according to an embodiment of this disclosure;

FIG. 14 illustrates an example K-1 schema organization for header information in the .K-1X document according to an embodiment of this disclosure;

FIG. 15 illustrates an example K-1 schema organization for certification information in the .K-1X document according to an embodiment of this disclosure;

FIG. 16 is a simplified block diagram showing an example K-1 exchange according to an embodiment of this disclosure;

FIG. 17 is a simplified block diagram showing an example environment of the K-1 exchange during operation according to an embodiment of this disclosure;

FIG. 18 is a simplified flow diagram of at least one embodiment of a method for recipient information reporting with the K-1 exchange;

FIG. 19 is a simplified flow diagram of at least one embodiment of a method for registering and verifying legal entities with the K-1 exchange;

FIG. 20 is a simplified flow diagram of at least one embodiment of a method for registering and verifying legal entities with the K-1 exchange;

FIG. 21 is a simplified flow diagram of at least one embodiment of a method for electronically signing certain documents for the K-1 exchange;

FIG. 22 is a simplified block diagram of at least one embodiment of the K-1 exchange interacting with an external application/process through an API;

FIG. 23 is a simplified block diagram of at least one embodiment of a confidential document exchange;

FIGS. 24 and 25 are simplified diagrammatical representations of example blocks in a blockchain used in conjunction with the confidential document exchange shown in FIG. 23; and

FIGS. 26-29 illustrate a simplified flow diagram of at least one embodiment of a method executed by the confidential document exchange.

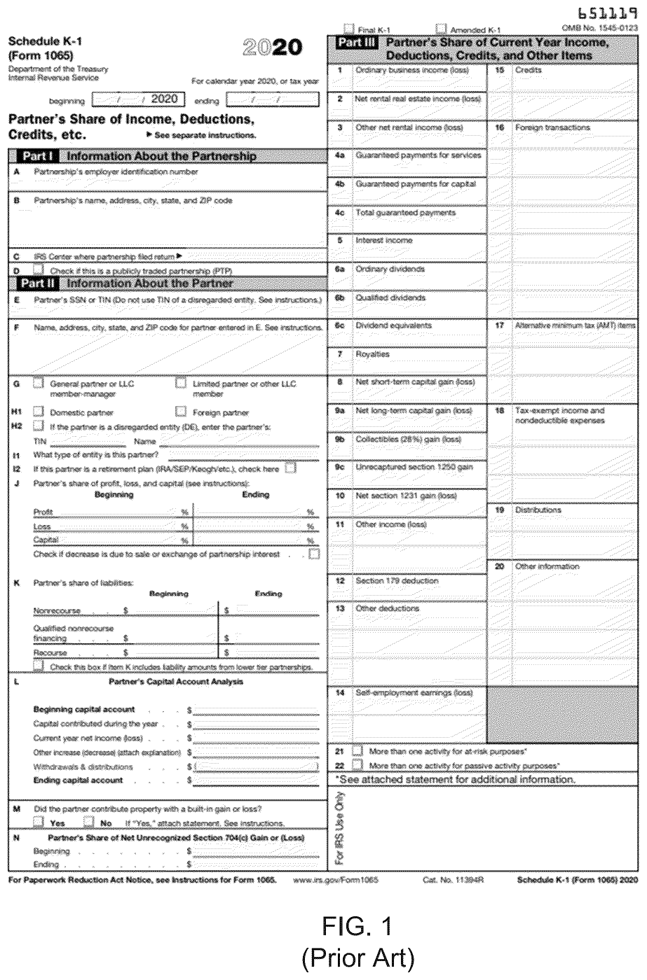

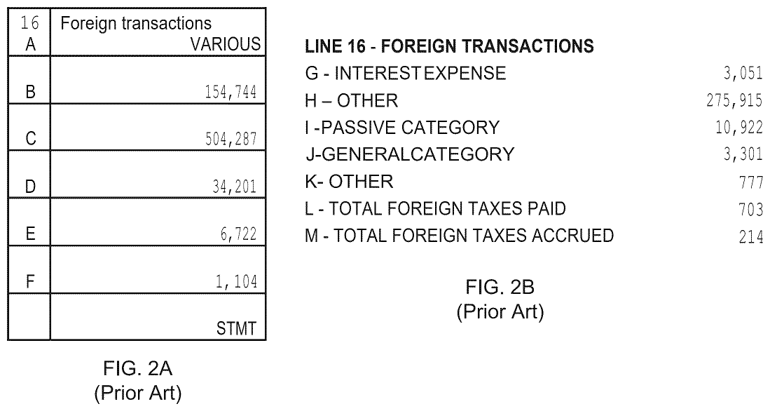

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

In some embodiments, this disclosure provides a system including a universal schema for the thousands of data points needed to provide federal, state and international information. The system includes logic built into the schema where it determines the specific information needed for each of the different legal entities that would receive a Schedule K-1 and their respective data needs. These legal entities include:
Corporation
Disregarded Entity
Estate
Fiduciary
Grantor Trust
Individual
Nominee
Partnership
Individual Retirement Account
S Corporation
Trust
Exempt Organization
Limited Liability Company
Limited Liability Partnership
Foreign Government

Combining the universal schema with entity-specific logic will significantly streamline the process but the facilitation of the data transmission is the last piece of the puzzle. In some embodiments, the system allows the seamless, digital transmission of data between these two worlds, and that seamless digital transmission of data will be facilitated by a K-1 Exchange. For example, K-1 receivers could post out to the K-1 Exchange all of their demographic information, and that data could then be automatically pulled into the world of the K-1 producers, who would then use it to create K-1s that have the correct demographic information on them. Additionally, K-1 receivers can provide their composite and withholding eligibility information so that the K-1 producers automatically receive it and have all of the information that they need to properly handle state and local taxes.

Once the K-1 producers have all the information that they need to do their work, they can then complete their K-1s and provide all of the necessary federal, state, international, capital, and basis details seamlessly and digitally to the K-1 receivers. This enables having all of that data automatically show up in the correct spot with no human data entry necessary for the K-1 receivers.

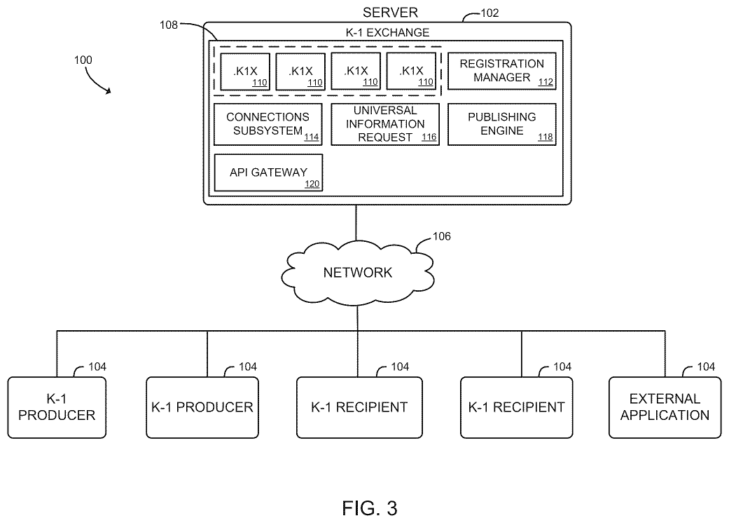

Referring now to FIG. 3, an embodiment of a system 100 for K-1 exchange with one or more servers 102 in communication with multiple computing devices 104 over a network 106 is shown. In the example shown, multiple computing devices 104 are associated with K-1 producers; some computing devices 104 are associated with K-1 recipients; and some computing devices 104 are associated with an external application/process that access the servers 102 via an API gateway. Although five computing devices 104 are shown for purposes of example, but more or less could be in communication with the servers 102. Typically, hundreds or thousands of computing devices 104 may be in communication with the server 102. Likewise, even though a single server 102 is shown for purposes of example, more servers 102 could be provided depending on the circumstances. For example, the server 102 could be a cloud-based platform with a plurality of servers accessible through the network 106. Embodiments are also contemplated in which the server 102 could establish a cloud-based platform (e.g., SaaS platform) through which computing devices 104 may send messages using an app running on the Android™ operating system by Google, Inc. of Mountain View, California and/or an app running on the iOS™ operating system by Apple Inc. of Cupertino, California on which software has been installed to perform one or more actions according to an embodiment of the present disclosure. Although the system 100 may be a cloud-based platform accessible by the computing devices 104, in some embodiments one or more features of the server 102 could be performed locally on the computing devices 104 depending on the circumstances.

The server 102 and/or computing devices 104 may be embodied as any type of computation or computer device capable of performing the functions described herein, including, without limitation, a computer, a server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Depending on the circumstances, the server 102 and computing devices 104 could include a processor, an input/output subsystem, a memory, a data storage device, and/or other components and devices commonly found in a server or similar computing device. Of course, the server 102 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory, or portions thereof, may be incorporated in the processor in some embodiments. The server 102 and computing devices 104 may include a communication subsystem, which may be embodied as any communication circuit, device, or collection thereof, capable of enabling communications between the server 102 and computing devices 104 over the network 106. For example, the communication subsystem may be embodied as or otherwise include a network interface controller (NIC) or other network controller for sending and/or receiving network data with remote devices. The NIC may be embodied as any network interface card, network adapter, host fabric interface, network coprocessor, or other component that connects the server 102 and computing devices 104 to the network 106. The communication subsystem may be configured to use any one or more communication technology (e.g., wired or wireless communications) and associated protocols (e.g., Ethernet, InfiniBand®, Bluetooth®, Wi-Fi®, WiMAX, 3G, 4G LTE, etc.) to effect such communication.

In an illustrative embodiment, the server 102 establishes an environment during operation to provide one or more features of a K-1 Exchange 108. In the example shown, the K-1 Exchange 108 includes a collection of .K-1X documents 110, a registration manager 112, a connections subsystem 114, a universal information request 116, a publishing engine 118, and an API gateway 120. As shown, the various components of the environment K-1 Exchange 108 may be embodied as hardware, firmware, software, or a combination thereof. As such, in some embodiments, one or more of the components of the K-1 Exchange may be embodied as circuitry or collection of electrical devices (e.g., registration manager circuitry 112, connections subsystem circuitry 114, universal information request circuitry 116, publishing engine circuitry 118, and API gateway circuitry 120). It should be appreciated that, in such embodiments, one or more of the registration manager circuitry 112, connections subsystem circuitry 114, universal information request circuitry 116, publishing engine circuitry 118, and API gateway circuitry 120 may form a portion of the processor, the NIC, the I/O subsystem, and/or other components of the server 102 and/or computing devices 104. Additionally, in some embodiments, one or more of the illustrative components may form a portion of another component and/or one or more of the illustrative components may be independent of one another.

### Digital K-1 (.K-1X file)

As discussed herein, the K-1 Exchange 108 is configured to generate, at least in part, a plurality of structured data files representing K-1 data, which are represented by .K1X documents 110. The .K1X documents 110 are formatted according to a defined schema, which will be referred to as the K-1 schema. The .K1X documents provides a digital, standardized specification for the K-1 statement.

To understand the digital exchange of data between K-1 Producers and K-1 Recipients, one must first understand the concept of getting to the standardized specification of the .K1X documents. Consider a PDF file, there are many tools out in the market that can create/edit/transmit/read these files. Through much iteration, planning, etc., PDF files have become a widely adopted standard with universal specifications that must be adhered to in order to consume and process the .pdf file extension and use in resulting solutions. As explained herein, there is not a mechanism to provide the exact and holistic K-1 information to a receiving entity without some element of human interpretation or automation through a machine learning model that is still doing a similar interpretation as the human but in a much more scaled, sophisticated fashion, all still susceptible to incomplete/inaccurate information. Thus, the file format of .K1X documents 110, or also referred herein as the “Digital K-1,” is the answer to provide the standardization for K-1s.

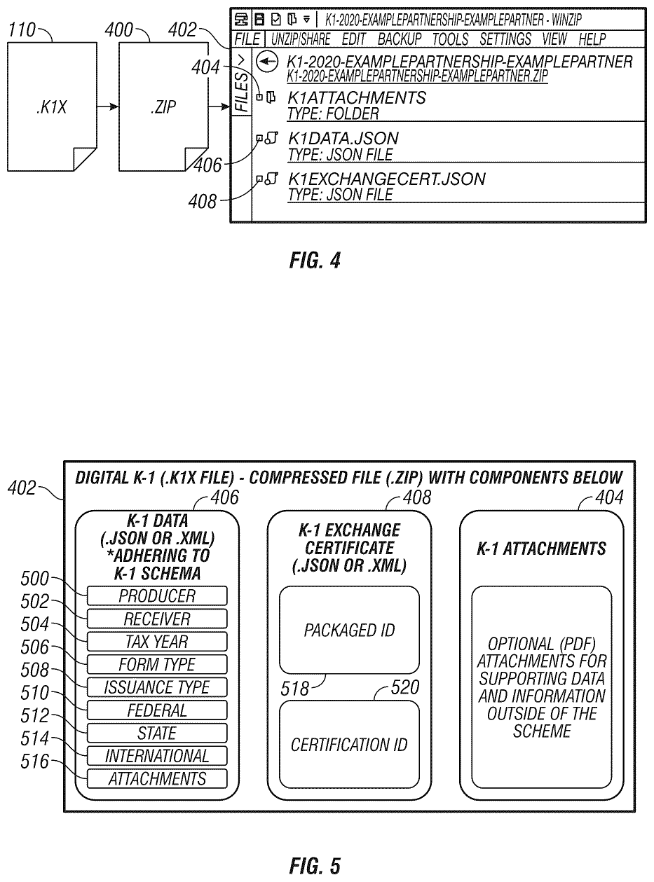

Referring now to FIG. 4, there is shown an example. K1X document. In some embodiments, at its core, the .K1X document is a combination of structured data files in json (JavaScript object notation) or xml (extensible markup language) format adhering to a defined schema (the K-1 schema) along with the option to provide additional attachments with supporting information outside of the K-1 schema. In the example shown, the file extension of .K1X is the indicator for a consuming application to know what specification to expect, which can then be viewed as a zip file 400 to become uncompressed and the contents 402 can be unpacked for processing. In the example shown, the contents 402 include K1Attachments 404, K1data.json 406, and K1exchangecert.json 408. Of course, the “.K1X” extension is provided for purposes of example, but other naming schemes for the extension could be used.

FIG. 5 illustrates an example high-level overview of the contents 402 that may make up the composition of the uncompressed .K1X document 110. In the example shown, the .K1X document 110 comprises K-1 data 406, K-1 exchange data 408, and K-1 attachments 404. Each of the components 406, 408, 404 will be discussed in turn.

In some embodiments, the K-1 data 406 portion of the .K1X document 110 is in. XML or .JSON file format; however, other formats could be used depending on the circumstances. The K-1 data 406 is the core component of the .K-1X document 110, which contains the necessary, structured information for the recipient for their K-1 reporting. In some embodiments, the K-1 data 406 includes one or more of the following:
Producer 500—This contains the information of who the K-1 Producer is issuing the K-1, which includes the Legal Entity Name, Address, and Tax ID.
Recipient 502—This contains the information of who is receiving the K-1 which includes the Legal Entity Name, Address, and Tax ID.
Tax Year 504—This specifies which Tax Year the K-1 corresponds to (i.e.—2020). This is required and important as it will drive which version of the K-1 schema to validate the K-1data file against since data points and requirements of a K-1 is subject to change from year to year.
Form Type 506—This specifies which type of K-1 (1065, 1120-S, or 1041) is being issued, similar to the Tax year data element it is required because it will drive which version of the K-1 schema to validate the K1data.json file against since data points and requirements of each K-1 form type is subject to change from year to year.

Issuance Type 508—Throughout the year a producer of a K-1 may report multiple times K-1 data to assist their receivers in their own tax planning activities. The issuance types for most K-1s is either an estimate, draft, or final. It is important for a producer to specify this as it will drive downstream decision making and logic for a receiver when they consume the data.

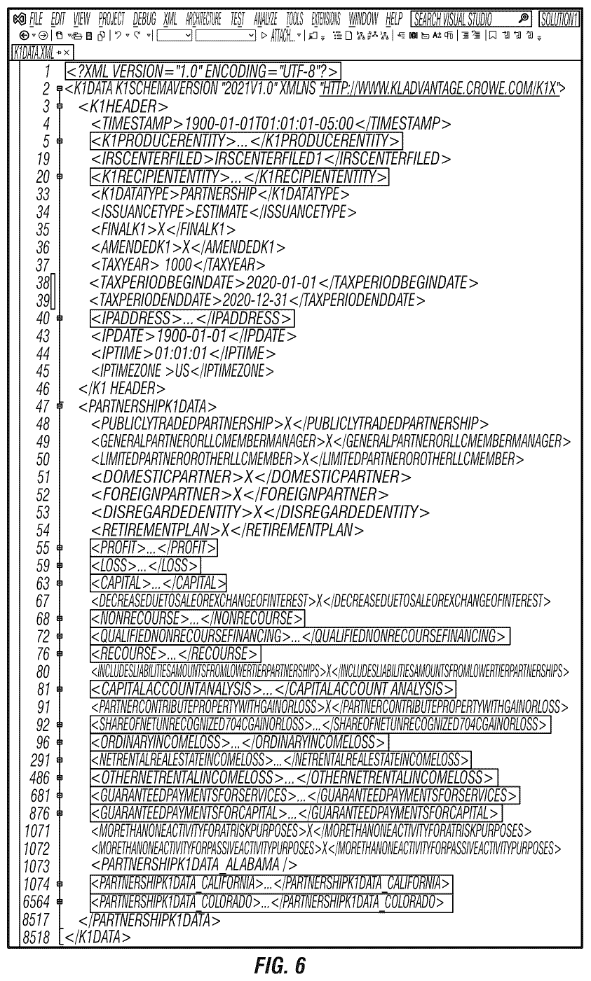

The data file 402 can also contain K-1 data relevant to Federal 510, State & Local 512, and International (Foreign) 514 reporting requirements. It is not required to provide all three of the components 510, 512, 514 in one file, due to the fluid nature of K-1 reporting throughout a compliance season, there could be multiple digital K-1 files distributed to a receiver. For example, the producing entity may deliver Federal K-1 data 510 only early on in the process, then once state information 512 is finalized they can build a separate. K1x document 110 containing only the new state information 512. In some cases, there may be one or more attachments 516 in the data file 402. FIG. 6 illustrates an example XML file representing the data file 402. The contents of the data file 402 will adhere to a K-1 Schema, an embodiment of which is outlined herein.

Referring again to FIG. 5, some embodiments of the K-1 exchange certificate 408 of the .K1X document 110 include a package ID 518 and a certification ID 520. The K-1 exchange certificate 408 portion of the .K1X document 110 may be in .XML or .JSON file format; however, other formats could be used depending on the circumstances. Part of what makes the .K1X document 110 an official .K1x file is the importance of validation and “certifying” it through the K-1 Exchange 108. That certification solves a technical challenge that exists today so that tax professionals will trust the source of the data and that the .K1X document 110 is complete, accurate, valid, etc. Secondarily, to protect the value of the .K1X document 110 and its downstream use for consumption in tax analysis and management tools, such as those offered by Crowe LLP of Chicago, Illinois as part of the K-1 Advantage™ ecosystem. In some embodiments, the K-1 exchange certificate 408 includes the following components:
K-1 Exchange Package ID 518—Unique ID (GUID, Globally Unique Identifier) stored in the K-1 Exchange 108 that this file is associated to.
K-1 Exchange Certification ID 520—Unique ID (GUID, Globally Unique Identifier) stored in the K-1 Exchange 108 that this file has been validated and certified “approved” by the K-1 Exchange 108 to be used for downstream consumption.

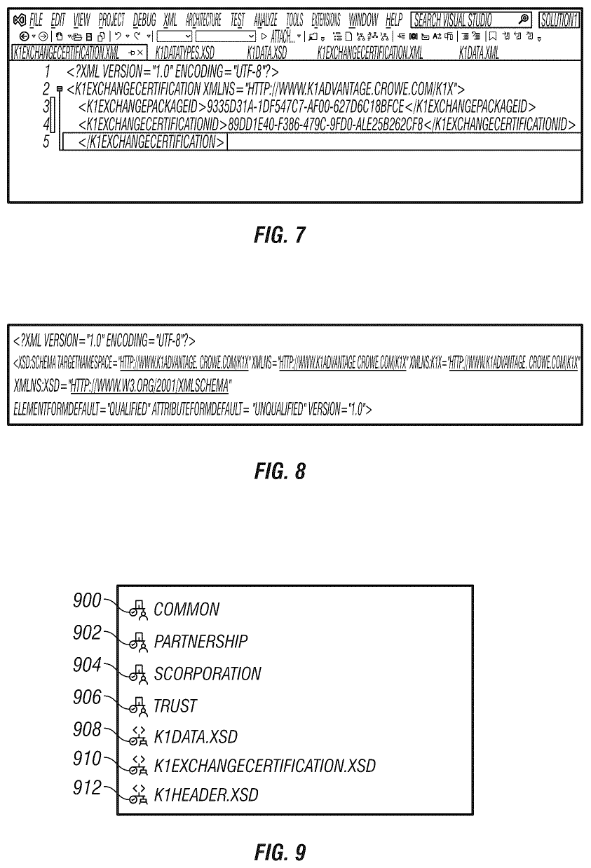

The creation of the K-1 exchange certificate 408 and how the certificate 408 is added to the .K1X document 110 is explained herein. An example K-1 exchange certificate 408 is shown in FIG. 7.

The .K1X document 110 may include K-1 attachments 404, which is an optional component of the Digital K-1 that may provide additional information that is outside the core K-1 Data file 406 that is supporting information in regards to the K-1 schema. An example of this might be the actual PDF(s) of the K-1s that were filed with the taxing jurisdictions to ensure the recipient as both their digital and pdf/electronic copy of their K-1s. The key for these attachments is to ensure they are communicated in the K-1 Data file, so there is some element of a lookup or “Table of contents” of what is provided in the subsequent attachments folder, it will help solutions downstream understand what they are consuming so they can route the information appropriately.

### K-1 Schema

At its highest level the K-1 schema, is a composition of data structures, types, and fields that follow a defined set of rules to follow when constructing a resulting file containing data relative to a K-1. In some embodiments, the schema is managed by a collection of .XSD (XML Schema definition) documents that specifies how to formally describe the elements of the K-1 in either a resulting .JSON file or as mentioned previously in the Digital K-1 file section, an .XML file (e.g.—K1Data.xml). The contents of these .xsds is an embodiment of more than 10,000+ fields that spans all required federal, state & local, and international tax data for three different flow-through entity types (Partnerships—1065, S-Corporations—1120S, and Trusts—1041). Typically, the schema definition is an annual activity, and it is assumed adjustments are made for future tax year support (including the potential for new jurisdictions).

In some embodiments, the K-1 schema is designed in what is called a “Venetian Blind Pattern”, which means the resulting xml data based off the schema contains only one global element. All the other elements are local. Element declarations are nested within a single global declaration by means of named complex types and element groups. Those types and groups can be reused throughout the schema and must define only the root element within the global namespace. This design is used for a couple purposes, it ensures one root attribute when the K-1data is submitted to inspect the contents of the file and it allows for re-use common schema types for similar data structures across the supported jurisdictions.

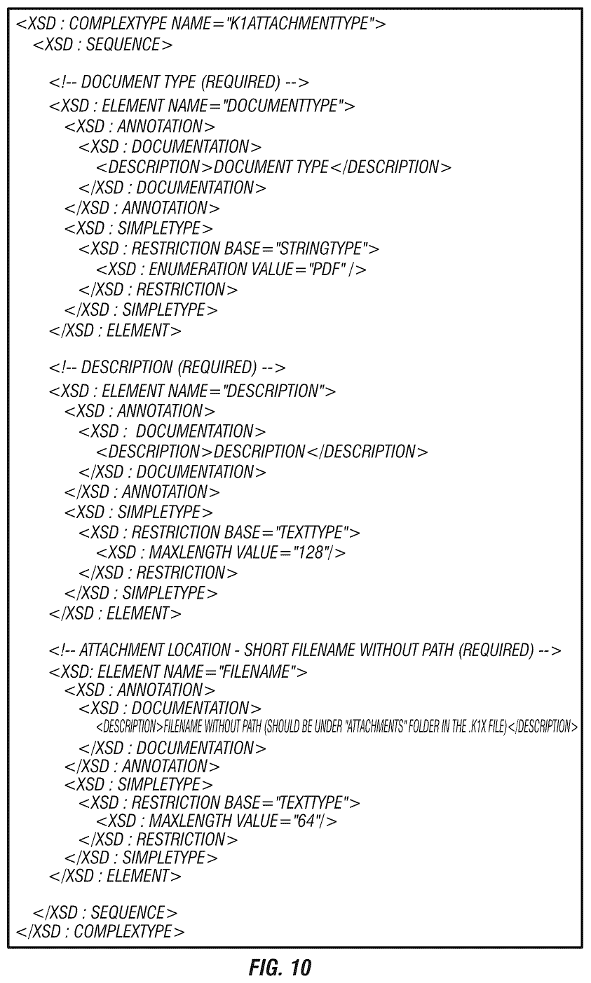

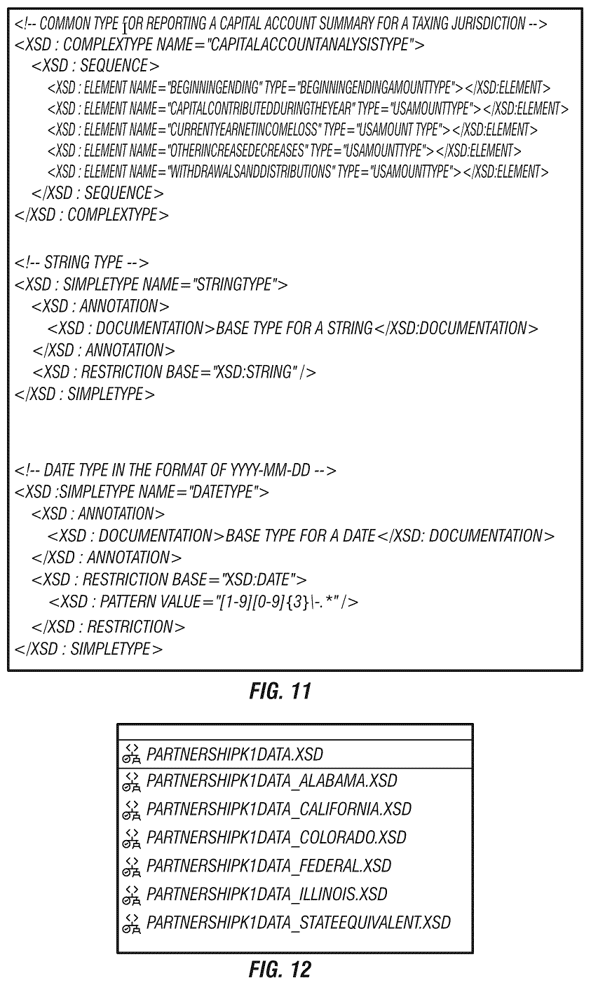

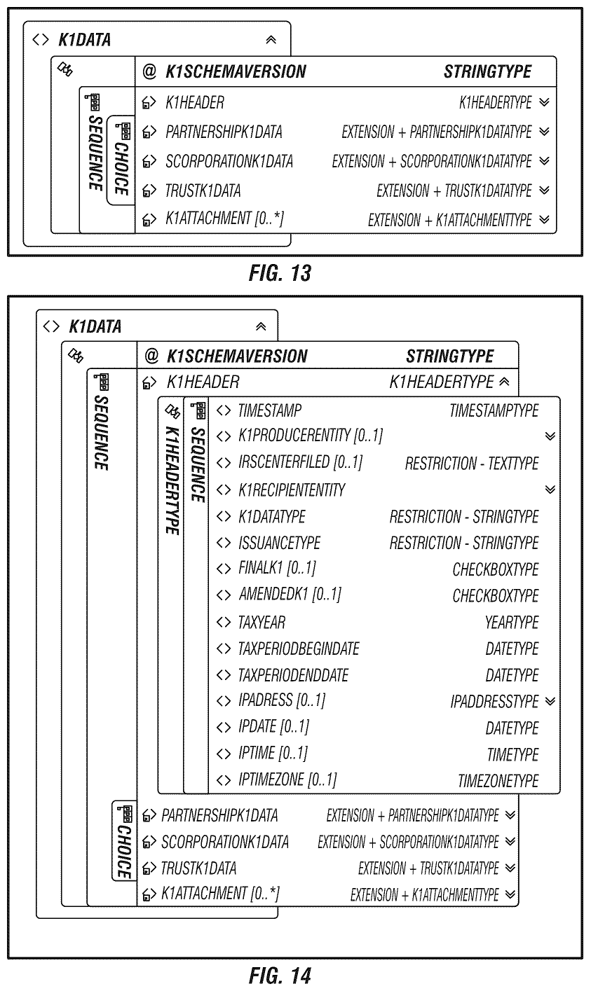

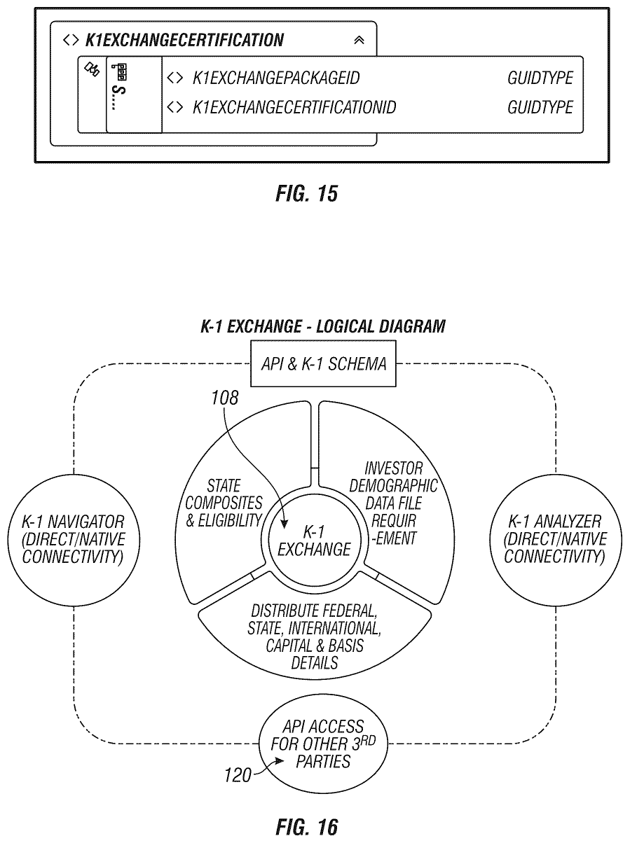

In some embodiments, all elements and types of the schema are defined under the “K1X” namespace which is a logical grouping container for a defined types and elements. In the example shown in FIG. 8, the schema definition files include a definition at the top of each file. In this example, this ensures all schemas fall under the common K1x namespace and are hosted at the K-1 Advantage public website. The schema is made publicly available so all parties in the K-1 ecosystem have access to the standard expectation of what should be contained in a digital k-1 file. The next layer down of the K-1 Schema is the main structure, which in some embodiments may be organized as shown in FIG. 9. In the example shown, the K-1 Schema may be organized as a common folder 900, a partnership folder 902, a SCorporation folder 904, a trust folder 906, a K1Data.xsd file 908, a K1ExchangeCertification.xsd 910 file, and a K1Header.xsd file 912. Each of these is discussed in turn.
Common 900—This folder, in some embodiments, contains common data types that can be re-used, define data constraints, and nest complex structures across the main schemas that contain the data element definitions. In some cases, this folder may include a K1Attachment.xsd file, which is a base complex type defining the structure of specifying what attachments are located in the “Attachments” 404 portion of the .K1X document 110 outside of the K-1 data portion 406. An example K1Attachment.xsd file is shown in FIG. 10. In some cases, the common folder 900 may include a K1DataTypes.xsd file, which is a collection of base data and complex types that are references for elements defined in later schemas. An example of this file with example types that can found in the file is shown in FIG. 11.
Partnership 902, S-Corporation 904, and Trust 906 folders—For each K-1 type the schema supports (e.g., 1065 Partnerships, 1120-S S-Corporations, and 1041 Trusts) there are specific data elements and structures that pertain to them, but as mentioned in the previous point there is still the common elements shared across each type. FIG. 12 is an example showing the underlying contents of an example Partnership folder 902, where there is a root element schema file, PartnershipK1Data.xsd, supporting schema files specific to each jurisdiction (i.e.—PartnershipK1Data_California.xsd), and common schema files that is re-used for describing different elements with the same data structure (i.e.—StateEquivalent.xsd is a common complex type used for jurisdictions that don't have any formal K-1 reporting but require a common set of data reported for them, such as the states of Florida and Michigan).
K1Data.xsd 908—This is the main schema file that brings everything together and tied back to the design pattern mentioned earlier in the resulting xml file defines the global element of “K1Data” in which every other element is nested under. FIG. 13 shows example components of the K1Data type. In the example shown, the starting point is the K1Header, which as explained herein, is a choice between PartnershipK1Data, SCorporationK1Data, or TrustK1Data, then capped off with the K1Attachments element in accordance with the K1AttachmentType previously mentioned.
K1Header.xsd 912—This portion of the K-1 schema defines the high level attributes of the contents of the K1Data file 406, and can almost be thought of like a “cover letter” so a consumer knows what to expect in the result detailed sections of the K-1Data document 110. An example of the K-1Header.xsd 912 is shown in FIG. 14. The Timestamp and IP data elements are important for traceability to understand when the K-1 data file was created and where at. K1ProducerEntity and K1RecipientEntity are the elements that describe the parties engaged in the K-1 data file (producer and receiver). Tax Year drives what tax reporting year the data is subject to. IssuanceType, FinalK1, AmendedK1 are all attributes describing the “State” of the K-1. For example, the IssuanceType may be classified as “Estimate”, which indicates to the receiver of the data that this is not final and the actual data comes later in the compliance season.
K1ExchangeCertification.xsd 910—In some embodiments, the final high-level schema file is not an element tied to the K1Data document 110, but a separate global/root element to create a separate XML (or json) file ensuring the digital k-1 file created has been submitted, validated, and transmitted via the K-1 exchange 108. In the example shown in FIG. 15, there are only two attributes required in this schema. The first is the K1ExchangePackageID, which is a globally unique identifier (GUID) representing the record id of the .K1X document 110 stored on the K-1 Exchange 108, the K-1 Exchange API 120 has an endpoint to validate the ID is a record in the system 100. The second is the K1ExchangeCertificationID, which is another GUID representing a record in the K-1 Exchange that can be validated via an API endpoint 120, but also provide resulting information of the .K1X document 110 passing validation and certified as accessible via the K-1 Exchange 108.

In some embodiments, the K-1 schema includes versioning, which is an important aspect to any structured data created that must adhere to a specified schema. It is important to be able to create different versions of XML Schemas. In some applications, schemas need to change over time to meet new requirements that may emerge, as is the case with K-1s because new regulation and reporting requirements across all of these taxing jurisdictions are subject to change. It is often not practical to simultaneously replace all the deployments of the old schemas with the new ones. Thus, the K-1 schema and subsequently the .K1X documents 110 and K-1 Exchange 108 is designed in a manner to support different versions coexisting in the system. For example, an initial version of the K-1 Schema is defined and released for general availability, then a new law/regulation could be in put place in a particular jurisdiction in the middle of a time period before a new major version is released, the K-1 schema is updated with a minor version to support the additional data point, but then there is still support for the prior minor version in case producers or receivers of digital k-1s had plans/operations set forth expecting the prior version and the newly introduced minor version does not apply to them anyway.

Below is a high-level outline of how the versioning of the K-1 schema could be managed, note much like the explanation of the structure previously mentioned this mechanics/concepts of this applies to both XSD/XML and JSON schema medium formats in order to provide flexibility for the developing entity to best align their capabilities in those particular languages.
Version number scheme—In some embodiments, the version number scheme could be the Tax Year for which the schema applies (YYYY), the lower-case version initial (v), and the two-digit version number (N.N). An example of this scheme is 2020v.1.0.
Validating Schema Versions—In some embodiments, throughout the year, multiple versions of the K-1 Schema files are subject to changes and released. Depending on if the schema change is major or minor; processing applications (e.g.,—K-1 Navigator™, K-1 Exchange™) may not require the schema version found in the data to match the schema version used by the creator of the digital k-1 during validation. There is always one active validating schema version for the digital K-1 for a Tax Year. In rare circumstances, there may be more than one active validating schema version. In some cases, there may be minor schema changes. When a revised schema changes the increment for the minor number, a processing application will continue to accept digital k-1s composed using previous schema versions. When the minor number is changed, the processing applications decide for themselves whether they need to use the new version or not based on what is included in their software and what changes were made to the Schemas. Consider an example if the change affects a form or field not supported or applicable then electing to not use the newest version is an option. For example, if the current schema version is 2020v1.0 and the schema change is minor, the K-1Advantage™ ecosystems will assign the new number as 2020v1.1. The active validating schema version is 2020v1.1. A processing application, such as the K-1 Exchange 108 will continue to accept digital k-1 files composed using either version 2020v1.0 or 2020v1.1. Both versions will have a validation path to get their K-1 Exchange certificate file accompanied in the. K1x file. In some cases, there may also be major schema changes. When the K-1 advantage ecosystem issues a revised k-1 schema and changes the increment for the major number, all k-1 data files in the .K1x document 110 must be composed using the new version number. Consider an example in which the current version is 2020v1.1 and it is decided by the K-1 schema owners, it can no longer accept digital k-1s composed using schema version 2020v1.1 (or 2020v1.0), and it will assign the new number 2020v2.0. The active validating schema version is 2020v2.0. Back to the K-1 Exchange 108 as a processing application, a digital k-1 submitted with 2020v1.1 (or 2020v1.0) will be rejected for using an unsupported schema version and not receive the K-1 exchange certification file.

### K-1 Exchange

FIG. 16 shows a high-level example of the K-1 Exchange 108 as part of an example ecosystem, with a secure API gateway 120 facilitating all (or at least a portion) of the interaction. In some cases, certain tools, such as K-1 Navigator™, may have native capabilities embedded in them to abstract a more detailed integration with the K-1 Exchange 108, that otherwise can be accomplished through custom development to interact with other tools and processes.

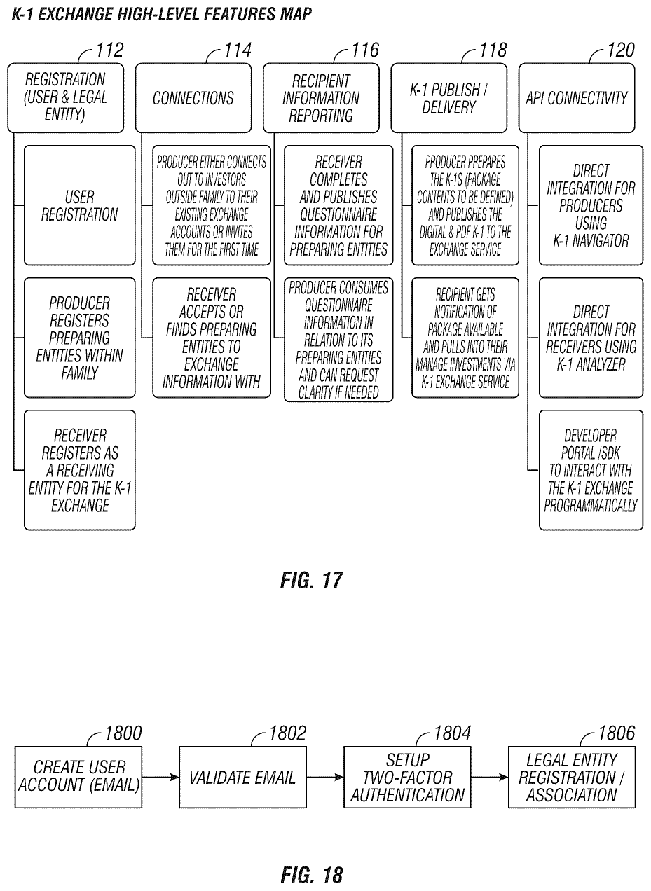

FIG. 17 illustrates example components of the K-1 Exchange 108 according to an embodiment. In the example shown, the K-1 Exchange includes a registration manager 112, a connections subsystem 114, a universal information request 116, a publishing engine 118, and an API gateway 120. Depending on the circumstances, some of these modules could be optional and other modules or functionality could be provided.

### User and Legal Entity Registration and Verification

The registration manager 112 is configured to register users with the K-1 Exchange 108. FIG. 18 illustrates example actions that could happen during the user registration process. As shown, the registration manager 112 could be configured to create a user account (block 1800), validate the email provided by the user (block 1802), setup a two-factor authentication (block 1804), and legal entity registration/associate (block 1806). In some cases, the following attributes may to be provided for the registered user in their profile:
Email (used for login ID)
First and Last Name
Password. In some cases, there could be password requirements, such as using at least 8 characters, 1 lowercase letter, 1 uppercase letter, 1 number, 1 symbol, does not contain username, first name, or last name, password expired every 45 days, locked out after 5 unsuccessful attempts, and/or automatically unlocked after 30 minutes

After the user provides the attributes to setup their profile, they are sent a verification link to the provided email address, the link contains a temporary/unique hash sent to only that email address. The user logs into their provided email account and clicks the unique link back to the K-1 Exchange 108 to conclude the validation of a legitimate email address provided by the user (block 1802).

To complete the user registration feature, users may be required to setup two factor authentication (block 1804) via a K-1 Exchange identity management service. The K-1 Exchange 108 may run through the following example steps to setup two factor authentication and additional security items.
User logins with their provided email and password from the registration laid out above.
A challenge question must be selected with a provided answer to use in case of a forgotten password.
The user will choose a security image that will appear each time logging into the K-1 Exchange to give the user feedback of assurance they are not a fraudulent application.
The user chooses from a list of options to facilitate the two-factor process. There may be multiple two-factor options, such as one or more of the following, Okta Verify—verify via the Okta Verify app on the user's device; Google Authenticator—verify via the Google Authenticator app on the user's device; SMS Authentication—verify via a text code sent to the user's phone; Email Authentication—verify via a code emailed to the user's email.

After setting up the additional security items and two factor authentication, the user's account registration is complete, they would move onto the legal account registration feature (block 1806) to either register new legal entities on the K-1 Exchange 108 of which they will administer, or request association to existing legal entities on the K-1 exchange 108 so they can be added as a contact to help administer activities for that legal entity.

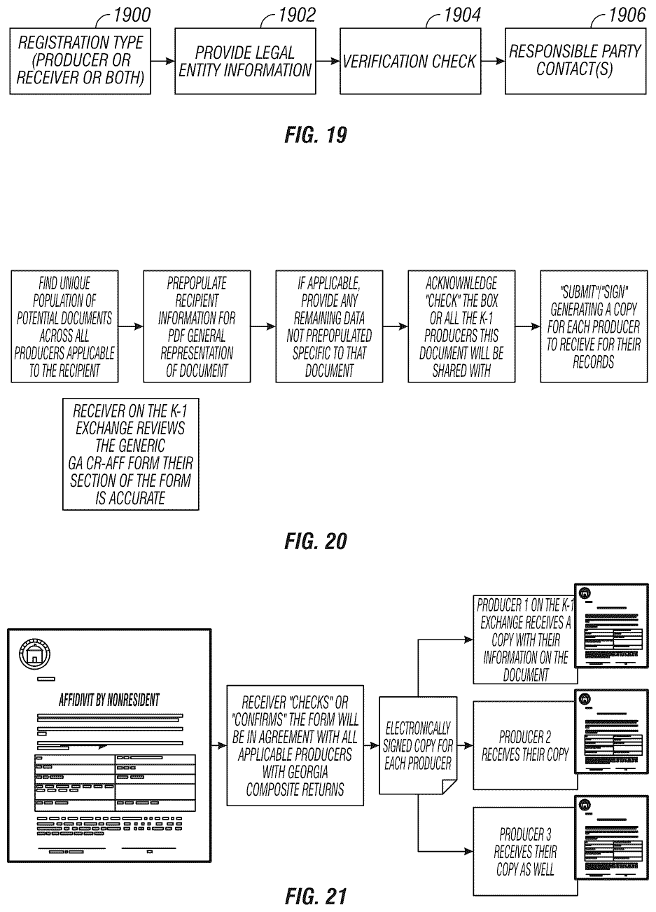

In order to interact either as a producer or receiver of K-1s a legal entity must go through a valid registration process to ensure its identification and unique account so when exchanging information the party on the other side can be guaranteed they are communicating with whom they expect. Registration is uniquely defined at the Legal Entity level, this is because a K-1 is the tax reporting document between two parties (Part A, the producer, and Part B, the receiver), which these entities are registered as unique taxpayers with the IRS. As illustrated in FIG. 19, to register a legal entity in the K-1 exchange 108, one or more of the high-level sequence of steps are conducted. The legal entity registering for the K-1 Exchange will specify if they are registering as either a producer, receiver, or both of K-1s as this will be important to drive additional functional capabilities for the legal entity downstream within the K-1 Exchange 108 (block 1900). If registering as a producer, this will ensure/enforce the legal entity type in the next step (block 1902) should be a Partnership, S-Corporation, or Trust. Next, the legal entity information is provided (block 1902). The legal entity type will be selected (e.g., one of the prior fifteen options mentioned earlier in the document). The name, taxpayer identification number (SSN for individuals, EIN for non-individuals), and primary address/legal domicile may be provided. Depending on the circumstances, other information may be requested through the legal entity registration process.

There may then be a verification check (block 1904). For example, for each legal entity registering on the exchange, digital identity verification may be provided. The verification requirements may be slightly different for individuals and non-individuals. For example, for non-individuals, a combination of the following options in conjunction of the required legal entity information mentioned above may be provided to ensure identity: official website (or affiliated website), email domain for valid users with administration rights to the legal entity account, documentation (examples would be letters of incorporation or partnership agreements), etc. For individuals, a combination of the following options in conjunction of the required legal entity information mentioned above may be provided to ensure identity: ID verification (official government issued identification) and completion of identity history questionnaire. Since the verification of an individual is a little bit more meticulous to track down as opposed to a legal entity, services from providers specializing in digital identity verification may be leveraged. In some cases, the identity history questionnaire may include one or more of the following: build the request for identity history, send the request to the expected ID service, processing an XML Response for a list of questions for the end user to validate their identity, Submitting the answers to the questions, and process an XML response with a pass/fail result for each answer submitted.

Next, the contact information for the responsible part(ies) is provided (block 1906). For individual legal entity accounts, there could be requirements in which primary user account (email) must be identified and this contact must have completed in the user registration. If additional user accounts end up being associated to the legal entity account, there could be requirements for at least 1 primary user account established to ensure a governing approval/verification of the additional users. For non-individual legal entity accounts, primary user account (email) must be identified and this contact must have completed the user registration. In some cases, the primary email address for the primary contact must have the email domain that represents the legal entity (e.g., Crowe LLP would be @crowe.com). If additional user accounts end up being associated to the legal entity account, there must be at least 1 primary user account established to ensure a governing approval/verification of the additional users.

### Connection Discovery Between Producing and Receiving Legal Entities

Once users and legal entities have been registered and verified on the system, the connection subsystem 114 is configured to facilitate connecting all of these legal entities together in a secure manner via a producer-receiver relationship that is mutually agreed upon between the two parties. Establishing this relationship can be initiated via either side, depending on which side initiates the discovery or “request to connect” the receiver of this request would then be responsible to accept/verify this.

Producers “Discover” their Receivers on the K-1 Exchange 108 and receivers verify/accept the connection. A legal entity that intends to produce and publish K-1s to their recipient group can request to connect/follow their recipients if those recipients have already registered on the K-1 exchange. Each producing entity maintains a list of their recipients as they need to file that with their parent federal return with the IRS (1065—Partners, 1120-S—Shareholders, and 1041—Trustees). Producers discover the recipients with the same unique information that the recipients registered with, such as:
Legal Entity Type (one of the prior fifteen options mentioned earlier in the document)
Taxpayer Identification Number (SSN for individuals, EIN for non-individuals)
Name of Legal Entity

Once the recipient is found the K-1 Exchange legal entity database, a connection request is sent from the producer with the intent “follow” for information requests received from the recipient and intent to “transmit” in order to digitally transmit K-1 information. The recipient receives this request in their K-1 Exchange connection inbox and accepts the connection. The previous steps are completed for each recipient the producer has an agreement with to communicate a K-1 to, if a connection has not already been requested and accepted from the recipient themselves.

Receivers “Discover” their Producers on the Exchange 108 and producers verify/accept the connection. A legal entity that intends to receive K-1s from a portfolio of producers can request to connect with these producers if they have already registered on the K-1 exchange. Receivers discover the producers with the same unique information that the producers registered with, such as:
Legal Entity Type (one of the three producer types, Partnership, S-Corporation, or Trust)
Taxpayer Identification Number (EIN)
Name of Legal Entity

Once the producer is found within the K-1 Exchange legal entity database, a connection request is sent from the receiver with the intent to “provide” information requests needed to be collected by the producing entity and subsequently intent to “receive” in order to digitally accept their K-1 information from the producing entity. The producer receives this request in their K-1 Exchange connection inbox and accepts the connection. The previous steps are completed for each producer the recipient has an agreement with to receive a K-1 from, if a connection has not already been requested and accepted from the producer themselves.

### Recipient Information Reporting (Demographic, Composite, Withholding)

To understand the next feature of Recipient information reporting, it is first important to note the background context of why this feature is needed. In order for producers to accurately report the K-1 information for each recipient an information request is typically conducted of their recipients. On the flip side, recipients on the K-1 exchange will have multiple producers they are working with they are fulfilling this information request to and repeat it for each connection, often seeing a duplication of requested information. The K-1 exchange 108 is designed for each recipient to provide their annual information request only once and each producer they have an established connection with can subscribe to pull that information down into their respective preparing tax workpapers. This information request is an annual activity; it is assumed adjustments made for future tax year support (including the potential for new jurisdictions), may be incorporated into the information request depending on the circumstances.

In some embodiment, the recipient information request could include one or more of the following components:
Demographics—Each legal entity receiving K-1 information via the K-1 exchange answers a series of questions relating to Federal and applicable State jurisdictions. The questions are logic-based with a series of dynamic rules applied to them to ensure question is applicable to one of the 15 entity types of recipients.
Composite—This is a series of questions for the recipient to map out their election and eligibility to be included on a composite filing that is handled by their producing flow-through entity (i.e.—State of Michigan Partnership Composite Return). For each jurisdiction the recipient could be subject to composite tax based on their investment portfolio (activity of the producers), they will be required to answer three basic questions, which help determine composite eligibility for that recipient, producer, jurisdiction intersection: (i) Apart from your interest in your investments, do you have an income tax filing requirement in the state? (ii) If yes, is all that income derived from flow-through investment entities? (iii) Do you want to be included in the composite filing if eligible? The answers to the previously mentioned questions are then used as inputs to determine final composite eligibility.
Composite affidavits with electronic signature—For each jurisdiction the recipient has elected to be on the composite return, some jurisdictions require a signed affidavit or multiple documents. These documents are automatically populated for each producer and jurisdiction combination the recipient has elected to from the composite portion of the information request.
Non-Resident Withholding and Mandatory Composite exemption forms with electronic signature—For each jurisdiction the producers may be responsible for either executing non-resident withholding or subject to mandatory inclusion of a recipient on the producer's composite return there may be an option to collect an exemption form for that jurisdiction and recipient type. Recipients (if applicable to their tax situation) can electronically sign these documents which are automatically populated with the recipient information and producer information where the exemption could be executed.

FIG. 20 illustrates example electronic signature functionality for State & Local Tax Composite/Withholding documents. In some embodiments, this electronic signature functionality could work similarly for a composite affidavit form and/or a non-resident withholding exemption form. Consider an example in which a recipient is a non-resident of Georgia, and will be receiving K-1s from producers of three different entities with activity in Georgia and the entity files a composite return in Georgia. The recipient wants to be included on all three of the entities composite return, but before the final determination of their eligibility to be included they need to provide a signed Georgia CR-AFF form for each producer's records to have on file. The K-1 exchange 108 simplifies this process through the functionality outlined herein where the recipient views a generic/populated CR-AFF Form, then confirms which producer entities will receive the form, and the K-1 Exchange 108 conducts electronically signing the document on behalf of the receiver's confirmation to each producing entity turning in this example what was one action for the user into three required deliverable outputs. FIG. 21 illustrates this example. Once the information request is complete by the recipient, the request is submitted for final validation to confirm an appropriate submission. The submitted request is not available for producers to subscribe to pull the information down into their respective processes and tooling as needed.

### Digital K-1 Publishing to the Exchange by Producers

As producers of K-1s, the key feature for them in the K-1 Exchange is the ability to publish their generated and/or construct their Digital K-1 files so they are transmitted for each recipient for whom they are obligated to report. The following outlines how the K-1 Exchange 108 facilitates this publishing. The K-1 Exchange 108 user securely connects/authenticate, and navigates to the specific Account/Legal-Entity combination for the K-1s they wish to publish. In some embodiments, if the option to publish digital K-1(s) information to the Exchange 108 is chosen, the user must specify if they already have a digital K-1 constructed, or need the assistance of the K-1 exchange to package up the component. If they require the K-1 exchange to construct the digital K-1, they complete the following steps: (i) specify issuance type (Estimate, Draft, Final), (ii) upload their K-1 Data (.XML or .JSON) file(s) adhering to the K-1 schema for each K-1 receiver they intend to publish, (iii) upload any additional PDF attachments (i.e. the physical K-1 files) for each K-1 receiver they intend to publish. In some cases, it is possible the producer does not yet have the ability to create a K-1 Data file and only has PDFs of K-1s. In this event, they can still use the K-1 Exchange 108 for distribution, but their K-1 PDFs will be sent to the K-1 Reader for extraction, the results are then parsed to a usable K-1 Data format to its best abilities. Once the Digital K-1s are uploaded and constructed, the next step will be to validate their contents. For each Digital K-1 that passes the required validation, the K-1 Exchange 108 will generate a K-1 Exchange Certificate file in either XML or JSON to match the K-1 Data file format. Having this file will give the downstream receiver the guarantee their Digital K-1 has gone through the proper quality checks for safe consumption. After the producer completes the publishing portion for the Digital K-1s, the K-1 Exchange 108 manages any and all notifications to inform the receivers on the K-1 Exchange 108 their digital K-1s are available to the specified receiver group the producer is connected to.

### Digital K-1 Transmission from the Exchange for Receivers

As receivers of K-1s, the ability to receive their Digital K-1s so it can be consumed into their respective tax workpapers or application of choice. In some embodiments, the K-1 Exchange 108 facilitates receiving the Digital K-1 with one or more of the following steps: (i) the K-1 Exchange user securely connects/authenticates, and navigates to the specific account/legal-entity combination for the K-1s they wish to retrieve; (ii) once they have landed on the desired legal entity's dashboard, they will be able to view which K-1s they are expecting from connected producers, of those connections the ones that have gone through the functionality to publish K-1s will have a notification they are “ready” for the receiver to consume the Digital K-1; (iii) depending on the destination of the Digital K-1 there will multiple options for the receiver to choose from, such as downloading a PDF of K-1 and any other attachments (if provided), downloading the entire Digital K-1 (.K-1X file), and/or if the receiver is a user of a downstream tool, they may transfer directly into a downstream tool.

### API Connectivity via General API Gateway & Developer SDK

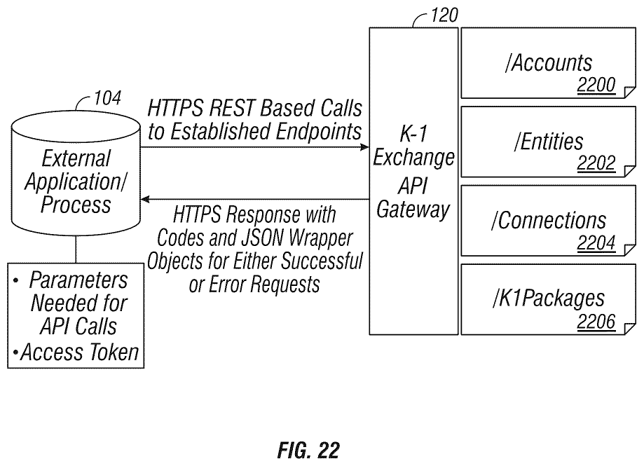

In some embodiments, one or more functions of the K-1 Exchange 108 is exposed through APIs 120 (Application Programming Interfaces) through a controlled gateway. FIG. 22 shows a high-level diagram showing the mechanics of an external application/process 104 interacting with the K-1 Exchange API 120 with endpoint resources (Accounts, Connections, K-1Packages, Certifications) that are accessible according to an embodiment. In some cases, the API 120 uses a REST based design, leverages the JSON data format for sending and receiving data, and relies upon HTTPS for transport. The responses from the K-1 Exchange gateway 120 are through HTTP codes and if an error occurs, included error details are provided in the response body. In some embodiments, an aspect of the K-1 Exchange API 120 is that it supports Cross-Origin Resource Sharing (CORS) which allows use of the API 120 directly from another web application. The API 120 may be secured by enforcement of TLS (SSL or HTTPS) on all communication to API endpoints. In some cases, the API calls must have a valid access token passed either in the request header or as a query parameter passed in the call.

In some embodiments, K-1 Exchange API resources require a valid access token for authentication. For example, there could be two ways to obtain access tokens: (i) Account Access Tokens; and/or (ii) OAuth Applications. Once an access token is obtained, the token could use HTTP Bearer Authentication, as defined in RFC6750 by the Internet Engineering Task Force (IETF), to authenticate when sending requests to the K-1 Exchange API 120. In some embodiments, there could be two methods supported to send the access token along in an API request: (i) authorization request header; and/or (ii) URI query parameter.

After an access token is obtained, one or more of the following API endpoints could be available in the K-1 Exchange 108 for programmatic interaction as opposed to interacting via direct, end-user, browser-based experiences. In some cases, not all K-1 Exchange 108 functionality will be available through the API gateway 120; for example, the recipient information reporting, could be made accessible through the API, but key functionality as it pertains to accounts, entities registered for the exchange, their connections with other entities, and K-1 package could be transmitted via the exchange 108. The endpoints shown in FIG. 22 are for purposes of example, but APIs and endpoints are always evolving, and more endpoints and variations of these are subject to change depending on the circumstances. In some cases, the endpoints may be accessed through the API 120 as follows:
Accounts 2200—For the provided access token, supplies a collection of accounts that can be taken action via the API.
Entities 2202—Legal entities registered on the exchange that belong to a specified account.
Connections 2204—connections established with other legal entities registered on the K-1 exchange with a provided legal entity in either a producer or receiver relationship.
K-1 Packages 2206—Digital K-1 files either produced and posted to the K-1 exchange or digital k-1 files that have been posted and can be download from the receiver perspective.

In some cases, there may be a K-1 Package Certification lookup underlying API calls tied to the packages, such as for endpoint access to an integration application; for example, package certification may be passed to tax tools inside the .K-1X file from the K-1 Certification .XML or .JSON file to ensure the authenticity and validate of the Digital K-1 about to be processed.

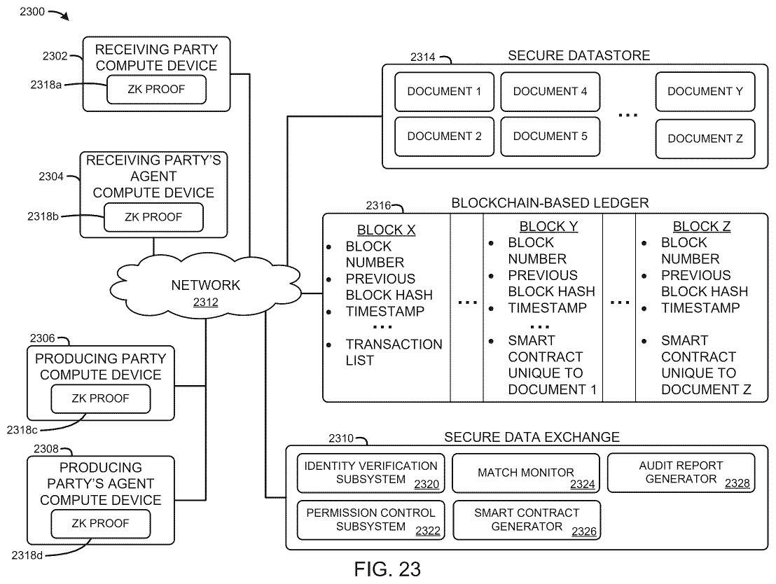

FIGS. 23-29 provide an illustrative embodiment of a system 2300 for secure document exchange. In some embodiments, the system 2300 is designed to facilitate the exchange of confidential documents between multiple parties-such as exchange of K-1 tax documents by general partners, limited partners, and their respective agents or accounting firms—while ensuring robust security, permission control, and auditability. In the example shown, the system 2300 leverages blockchain technology, smart contracts, and zero-knowledge proof (ZKP) authentication to manage document access and verify identities without exposing confidential information.

One technical problem solved by the system, in some embodiments, is timely and secure distribution of confidential documents. Consider an example in which an accounting firm of a general partner needs to distribute hundreds or thousands of K-1 documents to limited partners (or the limited partners' respective accounting firms). The IRS issued specific procedures for the electronic delivery of Schedules K-1 by partnerships (Rev Proc 2012-17). Partnerships are required to furnish partners with their Schedule K-1 (Partner's Share of Income, Deductions, Credits, etc.) on or before the due date of the partnership tax return. Failing to make this timely delivery subjects the partnership to penalties for late issuance. Furnishing Schedules K-1 to partners in an electronic format can be a much more efficient process than mailing or delivering by hand, but the requirements for disclosure, delivery, and consent can be challenging for the partnership and to do it at scale. The problems below often compound and exacerbate to create inefficiencies, delays, and security concerns, especially when the Partnerships issuing the K-1s may not know exactly or receive timely the issuance preference/requirements of the partners. All of the burden of capturing and providing electronic consent is on the shoulders of the general partner (GP). CPA Firms with their risk-adverse nature, coupled with these requirements will not deliver on behalf of the GPs, thus creating more delay and back-and-forth in the process. However, CPA Firms are best equipped to handle the distribution and collection of K-1s, but there is no scalable, auditable, secure manner for them to be granted authority.

Referring to FIG. 23, in the illustrative embodiment shown, the system 2300 includes a receiving party compute device 2302 (e.g., a compute device operated by a party that is to receive the confidential document, such as a limited partner to receive a K-1), a receiving party's agent compute device 2304 (e.g., a compute device operated by a party that is an agent to the receiving party, such as the receiving party's accountant), a producing party compute device 2306 (e.g., a compute device operated by a party that is to send a confidential document to the receiving party, such as a general partner to send a K-1 to a limited partner), and a producing party's agent compute device 2308 (e.g., a compute device operated by a party that is an agent to the producing party, such as the producing party's accountant).

These compute devices 2302, 2304, 2306, 2308 interact with a secure data exchange 2310 via a network 2312 to exchange one or more of the confidential documents in the secure datastore 2314 and have that exchange documented and managed by a blockchain-based ledger 2316. For example, the secure data exchange 2310 could generate one or more smart contracts that are loaded into the blockchain-based ledger 2316 to manage access to one or more confidential documents in the secure datastore 2314. In some cases, the secure data exchange 2310 may verify identity of parties providing access/seeking access to confidential documents with zero-knowledge proof (ZKP) authentication 2318a, 2318b, 2318c, 2318d provided by the parties.

A ZKP is a cryptographic method that allows one party (the prover) to prove to another party (the verifier) that a statement is true without revealing any details about the statement itself. The following outlines the components and how ZKPs could be captured through various workflows in some embodiments. In some embodiments, ZKPs could be created by each respective party/interaction, as discussed herein:
Producing party compute device 2306 (e.g., compute device operated by general partner) uploading their information validating their identity (ZKP 1)
Producing party's agent compute device 2308 (e.g., CPA firm of general partner) uploading their information validating their identity (ZKP 2)
Producing party compute device 2306 grant access/permission to distribute to producing party's agent (e.g., GP granting access to its CPA Firm) (ZKP 3)
Receiving party compute device 2302 (e.g., compute device operated by limited partner) uploading their information validating their identity (ZKP 4)
Receiving party compute device 2302 grant access/permission to receive to receiving party's agent (e.g., LP granting access to its CPA Firm) (ZKP 5)

In this example, with these ZKPs, the limited partners could validate their identity through ZKP2 and ZKP5 delegation of authority can now say “They want XYZ Partnership K-1” if that partnership is providing K-1s on the secure datastore 2314 through the secure data exchange 2310.

Another technical problem solved by this system 2300, in some embodiments, is party-initiated consent and access verification. Instead of the producing party (e.g., partnership) requesting and storing receiving party (e.g., partner) consent, the receiving party (partner) initiates consent within the system using a ZKP-based authentication process. The system verifies that the receiving party (e.g., partner) can access the required format without exposing unnecessary information (e.g., proving access without revealing exact device details). If the IRS requires proof of consent, the secure data exchange 2310 can generate a ZKP attestation confirming that consent was properly obtained at the time of first access, as discussed herein. This enables dynamic compliance in which consent and access verification update automatically with receiving party (e.g., partner) conditions since its sourced at the receiving party (e.g., partner) interaction and not requested by the producing party (e.g., partnership), reducing liability of the producing party (e.g., partnership). This provides cryptographic Proof without storing sensitive data. For example, if K-1s are the confidential documents being distributed, the IRS and auditors can verify compliance without exposing PII. Additionally, a CPA firm handling K-1s for multiple partnerships can instantly verify partner identities across multiple engagements without handling sensitive data directly to release the K-1s.

In the embodiment shown, the secure data exchange 2310 includes an identity verification subsystem 2320, a permission control subsystem 2322, a match monitor 2324, a smart contract generator 2326, and an audit report generator 2328. The identity verification subsystem 2322 is configured to verify the identity of receiving parties and producing parties. For example, the receiving and producing parties could provide ZK proofs 2318a, 2318c to the secure data exchange 2310 for verification. In some embodiments, the secure data exchange 2310 could provide ZK proofs 2318a, 2318c to a third party verification system to verify the identities of receiving/producing parties. The identity verification subsystem 2322 may be configured to likewise verify identity of agents of receiving/producing parties using ZK proofs 2318b, 2318d. In this manner, the disclosing/receiving parties' identity and identity of agents can be verified without the parties or agents revealing any personally identifiable information (PII).

The permission control subsystem 2322 is configured to verify authority of agents based on permissions granted by receiving/producing parties. In some cases, the permission control subsystem 2322 could use ZKP authentication to verify grants of permissions from receiving/producing parties, and authority based on permissions granted to agents. In this manner, the parties' grant of authority to agents can be verified without the parties or agents revealing any personally identifiable information (PII).

The match monitor 2324 is configured to facilitate matches between receiving parties and producing parties. When parties are matched, this allows secure document exchange therebetween for documents designed by the producing parties (or their agent(s)). For example, a general partner may be matched with or more a limited partners. In some cases, the match monitor 2324 could monitor for match requests from the receiving and producing parties. In some embodiments, the match monitor 2324 may require one or more proofs of the requesting party to authenticate a match between a producing party and receiving party. Once a match is authenticated between a producing party and receiving party, the producing party can distribute confidential document(s) to the receiving party. In this manner, the matches may also establish distribution paths for which documents go to which receiving parties. Once the connection is established, downstream delivery between matches does not need to be repeated in some embodiments.

The smart contract generator 2326 is configured to dynamically generate a smart contract in response to a producing party initiating distribution of a confidential document with a matched receiving party, and load the smart contract onto the blockchain-based ledger 2316. In some cases, the smart contract generated by the smart contract generator 2326 may be customized specific to the confidential document(s) to be distributed. For example, the smart contract may require specific access parameters, such as requiring the receiving party to certain credentials for authentication, to receive the confidential document(s). In some embodiments, the parameter for the receiving party could be based on the match information between the producing party and the receiving party. In some embodiments, the smart contract could provide the receiving party with access keys to gain access to the confidential document(s) specified in the smart contract from the secure datastore 2314. In some embodiments, one or more libraries of a programming language used to generate document-specific smart contracts could be used to dynamically create smart contracts, such as an open source project called Solidity™.

The use of dynamically-generated smart contracts for accessing confidential documents solves technical problem(s). Distribution of confidential documents is often compounded and exacerbated by inefficiencies, delays, and security concerns, especially when parties don't know or trust each other. In the context of distributing K-1s, for example, the “risk” for accounting firms (e.g. producing party agent) to take on ensuring K-1 delivery, where 8 or 9 times out 10 they'll pass that responsibility to the partnership (e.g., producing party) they are doing work for, especially with the aforementioned electronic delivery, disclosure, and consent requirements.

One issue is lack of trust between the producing and receiving parties. For example, in the context of distributing K-1s, many K-1 issuers (partnerships or CPAs) and receivers (partners or their CPAs) do not know each other. The partnerships must distribute K-1s to numerous partners, but verifying whether a recipient is authorized (without exposing unnecessary sensitive data) is a challenge. The information must remain secure, accurate, and timely for tax compliance; performing all the necessary requirements/security checks in a short window is difficult to scale. Additionally, issuers might worry about sending K-1s to the wrong party with the disparate delivery mechanisms.

Another issue is security and data privacy risks associated with distribution of confidential documents. When the confidential documents are K-1s, there is sensitive financial data (income, SSNs, EINs, ownership details). Most K-1s are exchanged via email, portals, or cloud storage, which are vulnerable to hacking and phishing attacks. Additionally, CPAs and firms must store K-1s securely but often rely on centralized solutions, increasing breach risks.

The distribution of confidential documents can also involve inefficient, manual processes. For example, CPAs and firms manually verify recipient identities, leading to delays. Additionally, sending K-1s typically requires email back-and-forth, logging into portals, and manual approvals. Some portals have poor user interface (UX), requiring extra steps like sending separate verification emails.

The audit report generator 2328 is configured to generate an audit report regarding access to the confidential document(s) in the secure datastore. By way of example, the audit report generator 2328 could collect information for the audit report based on one or more blocks in the blockchain-based ledger that were created via the smart contract(s). These blocks, similar to the example shown in FIG. 25, provide information on which specific documents were accessed, and when, and/or by whom. This audit trail created by the smart contracts in the blockchain-based ledger can be collected by the audit report generator 2328 and provided in a report.

Another technical problem the system 2300 overcomes, in some embodiments, is providing a tamper-proof audit trail for distribution of the confidential documents (e.g., K-1s). Current systems don't provide an immutable, verifiable record of K-1 exchanges. Auditors and tax authorities rely on trust rather than cryptographic proof that a document was properly delivered and received. The blockchain architecture with the use of the blockchain-based ledger 2316 fundamentally transforms how parties interact by substituting traditional trust requirements with cryptographic verification. This creates a “trustless” environment where transactions proceed securely even when participants do not know or trust each other. A blockchain is like a digital ledger that records transactions in a secure and tamper-proof way. Instead of one company or person controlling it, a blockchain is maintained by a network of computers that all agree on the information being recorded. Once data is added, it's nearly impossible to change, making it very trustworthy. A smart contract is like an automated agreement written in code that runs on a blockchain. It follows predefined rules and executes actions automatically when certain conditions are met.

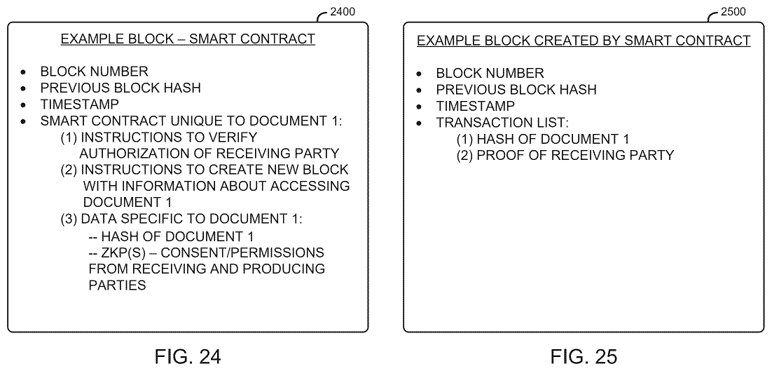

FIG. 24 shows a simplified example of a block 2400 with a smart contract that could be loaded onto the blockchain-based ledger 2316. In the example shown, the smart contract includes a block number, a previous block hash, a timestamp, and parameters of a smart contract that is unique to the confidential document to be distributed. In this example, the parameters of the smart contract include instructions to verify authorization of the receiving party, instructions to create a new block with information about the document to be accessed, and data specific to the document to be accessed, such as a hash of the document(s) to be accessed and/or ZKP(s) with consent/permissions from the receiving and producing parties. In some embodiments, the receiving party requesting access to one or more documents could make a call to the address of the block with the smart contract related to the requested document.

As discussed, the smart contract could be configured to create a new block on the blockchain-based ledger 2316 that reflects the access to the confidential document(s), which provides an audit trail for access to the confidential documents. FIG. 25 illustrates an example block 2500 that could be created when the smart contract is accessed and executed. In the example shown, the block created from accessing the smart contract includes a block number, a previous block hash, a timestamp, and a transaction list. As shown, the transaction list includes a hash of the document(s) that were accessed and proof (e.g., ZKP) of the receiving party.

While relatively few compute devices 2302, 2304, 2306, 2308 are shown in FIG. 23 for simplicity and clarity, it should be understood that the number of compute devices 2302, 2304, 2306, 2308, in practice, may range in the tens, hundreds, thousands, or more. Although a single secure data exchange 2310 is shown for simplicity in FIG. 23, the functionality of the secure data exchange 2310 could be distributed across multiple compute devices. Likewise, while a single blockchain-based ledger 2316 is shown for simplicity, the blockchain-based ledger 2316 could be distributed across multiple compute devices. Although three blocks X, Y, and Z are shown in the blockchain-based ledger 2316 for purposes of example, the blockchain-based ledger 2316, in practice, may include tens, hundreds, or thousands of blocks. Similarly, although a single secure datastore 2314 is shown for purposes of simplicity, the confidential documents distributed across multiple datastores.

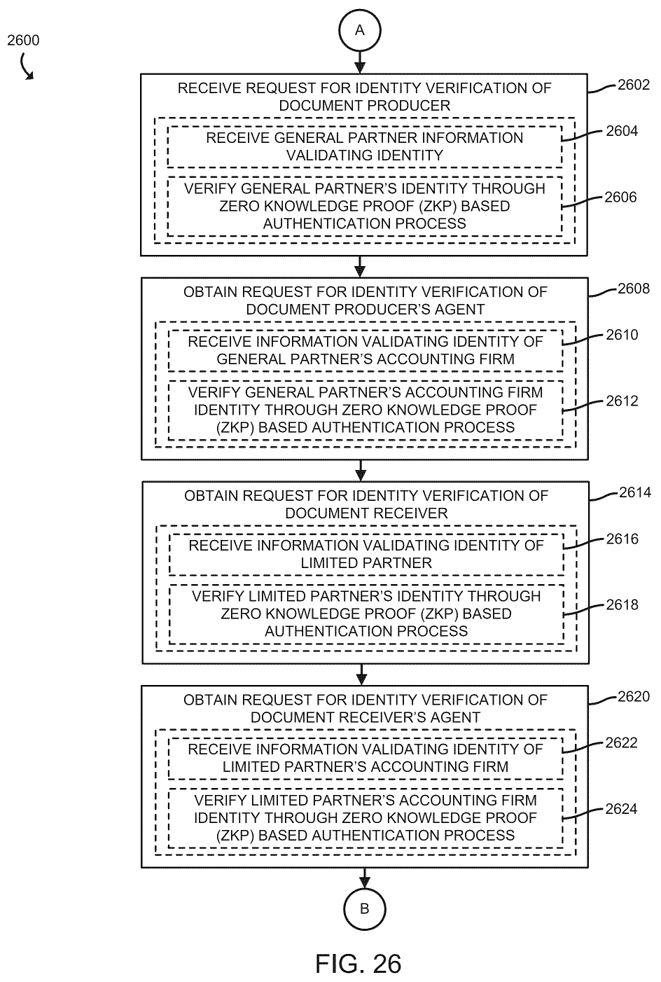

Referring now to FIGS. 26-29, there is shown a method 2600 that could be executed by the secure data exchange 2310 in some embodiments. The method 2600, in some embodiments, provides a secure, blockchain-based process for identity verification, permission authority management, matching of document producers and receivers, and dynamic document distribution using smart contracts. The method 2600 may leverage zero-knowledge proof (ZKP) authentication and smart contract automation to ensure secure, auditable, and permissioned access to sensitive documents among multiple parties, including in some cases, general partners, limited partners, and their respective agents or accounting firms.

In the embodiment shown, the method 2600 begins with a request for identity verification of the document producer (block 2602). In some cases, the request is received for validating identity of a general partner (block 2604). For example, the general partner's identity could be verified with a zero knowledge proof (ZKP) based authentication process (block 2606) which allows the secure data exchange 2310 to confirm the identity without revealing sensitive underlying data. The method 2600 advances to block 2608 in which the secure data exchange 2310 receives a request to verify the identity of the document producer's agent, such as the general partner's accounting firm (block 2610). The system collects the relevant information and again utilizes ZKP-based authentication to validate the agent's identity. For example, the general partner's account firm's identity could be verified with a zero knowledge proof (ZKP) based authentication process (block 2612).

A similar process is followed for the document receiver, which in some embodiments, may be a limited partner or its agent. The method advances to block 2614 in which a request for identity verification of the document receiver is received, such as receiving a request to validate the identity of the limited partner (block 2616), which could be done using a ZKP based authentication process (block 2618). If the request pertains to the limited partner's agent (e.g., their accounting firm), the system collects the required information and performs ZKP-based authentication to confirm the agent's identity. The method 2600 proceeds to block 2620 in which the secure data exchange 2310 receives a request to verify the identity of the document receiver's agent, such as one of the limited partner's accounting firm (block 2622). For example, the secure data exchange 2310 could collect the relevant information and utilize ZKP-based authentication to validate the agent's identity (block 2624). For example, the general partner's account firm's identity could be verified with a zero knowledge proof (ZKP) based authentication process (block 2612).

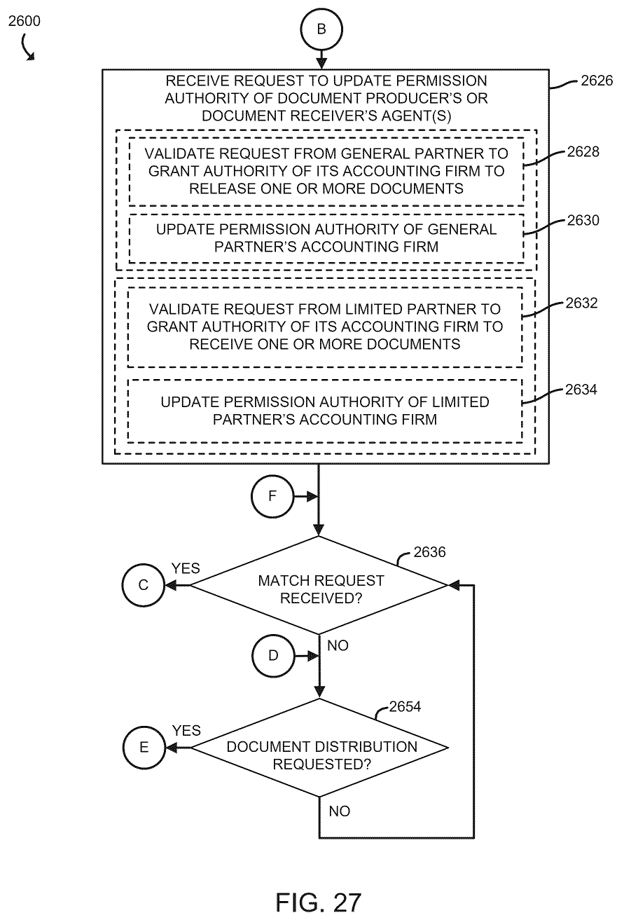

Referring now to FIG. 27, once identities are verified, the method 2600 proceeds to manage permission authorities for document access. The secure data exchange 2310 receives a request to update the permission authority of either the document producer's or receiver's agent (block 2626). For example, the secure data exchange 2310 could validate the request of a general partner to its accounting firm (or other agent) as indicated by block 2628. For example, a general partner may request to grant its accounting firm the authority to release one or more documents. The secure data exchange 2310 updates the permission authority accordingly as indicated by block 2630. Similarly for the document receiver, the secure data exchange 2310 could validate the request of a limited partner to its accounting firm (or other agent) as indicated by block 2632. For example, a limited partner may request to grant its accounting firm the authority to receive one or more documents. The secure data exchange 2310 updates the permission authority accordingly as indicated by block 2634.

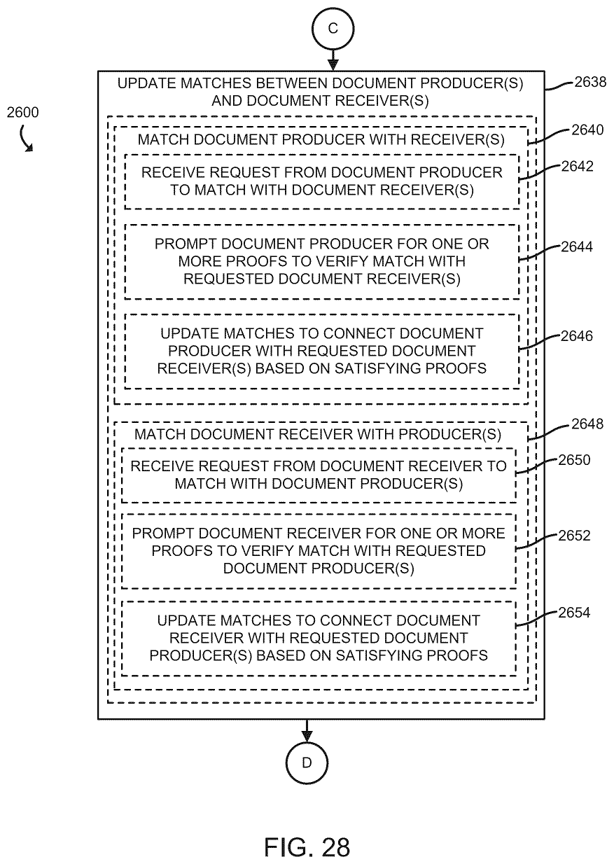

The secure data exchange 2310 could facilitate the matching of document producers and receivers. When a match request is received by the secure data exchange 2310, as indicated in block 2636, the method advances to block 2638 (FIG. 28) in which matches between document producer(s) and document receiver(s) are updated. In some embodiments, a document producer is matched with document receiver(s) (block 2640), by receiving a request from a document producer to match with document receiver(s) (block 2642). The document producer could be prompted for one or more proofs, such as ZK proofs 2318a, 2318b, 2318c, and/or 2318d, to verify a match with the requested document receiver(s) (block 2644). In some embodiments, the receiving party could be prompted for proof with other information, such as a identifier of the confidential document (e.g., K-1 account number), a trade verification of the receiving party, and/or an ending number of units or capital balance. Upon receiving satisfying proofs from the document producer, updating the matches to connect the document producer with the requested document receiver(s) (block 2646). Conversely to match a document receiver with a producer (block 2648). When a request is received from a document receiver to match with one or more document producers (block 2650), the secure data exchange 2310 could prompt the receiver for proofs to verify the match (block 2652). Once the proofs are satisfied, the secure data exchange 2310 updates the matches to connect the document receiver with the appropriate producers (block 2654).

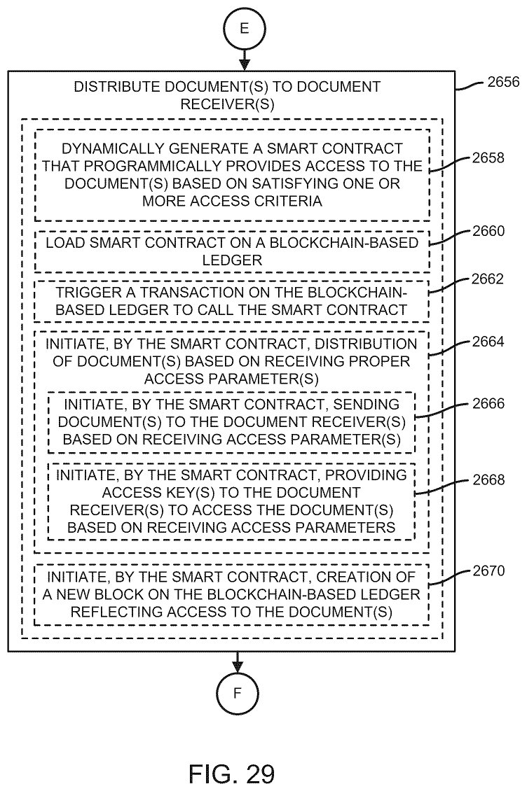

The method then advances to block 2654 in which a determination is made whether a document distribution has been requested. If not, the method 2600 continues to monitor for match requests. If a document distribution request is received, the method 2600 advances to block 2656 (FIG. 29) in which document(s) are distributed to document receiver(s). In some embodiments, the secure data exchange 2310 dynamically generates a smart contract that programmatically provides access to the document(s) based on satisfying one or more access criteria as indicated by block 2658, similar to the example smart contract in FIG. 24. The smart contract is loaded on the blockchain-based ledger 2316, as indicated by block 2660.

The distribution of the document(s) distributed to the receiving party and/or its authorized agent(s) is initiated by triggering a transaction on the blockchain-based ledger to call the smart contract (block 2662). The smart contract will initiate distribution of the document(s) based on receiving the proper access parameter(s) (block 2664). For example, the smart contract may initiate sending the document(s) to the document receiver(s) based on receiving the access parameters (block 2666). In some cases, instead of (or in addition to) sending the document(s), the smart contract could initiate distribution by providing access key(s) to the document receiver(s) based on receiving proper access parameters and from which the document receivers can download the document(s). The smart contract may also create a new block on the blockchain-based ledger reflecting access to the document(s) (block 2670), similar to the example block shown in FIG. 25. The method 2600 then returns to block 2636.

### EXAMPLES

Illustrative examples of the technologies disclosed herein are provided below. An embodiment of the technologies may include any one or more, and any combination of, the examples described below.

Example 1 is a digital tax data exchange system. The system includes a schema validation subsystem to validate one or more structured data files are formatted in accordance with a universal data schema based on entity-specific data requirements. The plurality of structured data files relate to K-1 producers, which are financial entities that issue schedule K-1 documents and K-1 receivers, which are persons to whom schedule K-1 documents are issued. In response to validating the one or more structured data files, the schema validation subsystem is to generate a validation certificate that is associated with the one or more structured data files. The system includes a registration manager, on one or more processors, to register a plurality of legal entities as a K-1 producer and/or a K-1 receiver as registered users in a database. The registration manager is to perform a digital identity validation process. The system also includes a connections subsystem, on one or more processors, to make connections between one or more K-1 producers and one or more K-1 receivers to establish access control therebetween. The access control between connected K-1 producers and K-1 receivers provides data access to one or more of each other's structured data files.

Example 2 includes the subject matter of Example 1, wherein the schema validation subsystem is to reject a data file inconsistent with the universal data schema.

Example 3 includes the subject matter of Examples 1-2, wherein the universal data schema requires structured data files with at least: (i) K-1 data; and (ii) a K-1 exchange certificate.

Example 4 includes the subject matter of Examples 1-3, wherein the (i) K-1 data; and (ii) an K-1 exchange certificate are bundled into a single data file.

Example 5 includes the subject matter of Examples 1-4, wherein the universal data schema further requires one or more attachment files.

Example 6 includes the subject matter of Examples 1-5, wherein the universal data schema requires structured data files with K-1 data including at least: (i) a producer identification; (ii) a recipient identification; (iii) a tax year; (iv) a form type; and/or (v) an issuance type.

Example 7 includes the subject matter of Examples 1-6, wherein the universal data schema requires structured data files with a K-1 exchange certificate including at least: (i) a package identifier that is a unique identifier associated with a structured data file, and (ii) a certification identifier that is a unique identifier indicating that the structured data file has been certified.

Example 8 includes the subject matter of Examples 1-7, wherein the universal data schema includes multiple versions, and the schema validation subsystem is to validate a version of the one or more structured data files.

Example 9 includes the subject matter of Examples 1-8, further comprising an API gateway to receive one or more structured data files.

Example 10 includes the subject matter of Examples 1-9, wherein the registration manager is to require identification of a legal entity as either a K-1 producer or a K-1 receiver to be registered users in the database.

Example 11 includes the subject matter of Examples 1-10, wherein the registration is to enforce a legal entity type, including taxpayer identification number, and contact information for a legal entity account to be created as a registered user in the database.

Example 12 includes the subject matter of Examples 1-11, further comprising a publishing engine, on one or more processors, to publish one or more structured data files based on one or more connections between one or more K-1 producers and one or more K-1 receivers.

Example 13 is a computerized method for digital tax data exchange. The method includes validating one or more structured data files are formatted in accordance with a universal data schema based on entity-specific data requirements. The plurality of structured data files relate to K-1 producers, which are financial entities that issue schedule K-1 documents and K-1 receivers, which are persons to whom schedule K-1 documents are issued. In response to validating the one or more structured data files, the method includes validating includes generating a validation certificate that is associated with the one or more structured data files. The method includes registering a plurality of legal entities as a K-1 producer and/or a K-1 receiver as registered users in a database, wherein the registering step includes a digital identity validation process. The method also includes making connections between one or more K-1 producers and one or more K-1 receivers to establish access control therebetween. The access control between connected K-1 producers and K-1 receivers provides data access to one or more of each other's structured data files.

Example 14 includes the subject matter of Example 13, wherein the validating step rejects a data file inconsistent with the universal data schema.

Example 15 includes the subject matter of Examples 13-14, wherein the universal data schema requires structured data files with at least: (i) K-1 data; and (ii) a K-1 exchange certificate.

Example 16 includes the subject matter of Examples 13-15, wherein the (i) K-1 data; and (ii) an K-1 exchange certificate are bundled into a single data file.

Example 17 includes the subject matter of Examples 13-16, wherein the universal data schema further requires one or more attachment files.

Example 18 includes the subject matter of Examples 13-17, wherein the universal data schema requires structured data files with K-1 data including at least: (i) a producer identification; (ii) a recipient identification; (iii) a tax year; (iv) a form type; and/or (v) an issuance type.

Example 19 includes the subject matter of Examples 13-18, wherein the universal data schema requires structured data files with a K-1 exchange certificate including at least: (i) a package identifier that is a unique identifier associated with a structured data file, and (ii) a certification identifier that is a unique identifier indicating that the structured data file has been certified.

Example 20 includes the subject matter of Examples 13-19, wherein the universal data schema includes multiple versions, and the schema validation subsystem is to validate a version of the one or more structured data files.

Example 21 includes the subject matter of Examples 13-20, further comprising an API gateway to receive one or more structured data files.

Example 22 includes the subject matter of Examples 13-21, wherein the registering step includes requiring identification of a legal entity as either a K-1 producer or a K-1 receiver to be registered users in the database.

Example 23 includes the subject matter of Examples 13-22, wherein the registering step includes enforcing a legal entity type, including taxpayer identification number, and contact information for a legal entity account to be created as a registered user in the database.

Example 24 includes the subject matter of Examples 13-23, further comprising publishing one or more structured data files based on one or more connections between one or more K-1 producers and one or more K-1 receivers.

Example 25 is one or more non-transitory, computer-readable storage media comprising a plurality of instructions stored thereon that, in response to being executed, cause a computing device to validate one or more structured data files are formatted in accordance with a universal data schema based on entity-specific data requirements. The plurality of structured data files relate to K-1 producers, which are financial entities that issue schedule K-1 documents and K-1 receivers, which are persons to whom schedule K-1 documents are issued. In response to validating the one or more structured data files, the instructions generates a validation certificate that is associated with the one or more structured data files. There are instructions to register a plurality of legal entities as a K-1 producer and/or a K-1 receiver as registered users in a database, which includes a digital identity validation process. There are also includes to make connections between one or more K-1 producers and one or more K-1 receivers to establish access control therebetween. The access control between connected K-1 producers and K-1 receivers provides data access to one or more of each other's structured data files.

Example 26 includes the subject matter of Example 25, wherein there are instructions to reject a data file inconsistent with the universal data schema.

Example 27 includes the subject matter of Examples 25-26, wherein the universal data schema requires structured data files with at least: (i) K-1 data; and (ii) a K-1 exchange certificate.

Example 28 includes the subject matter of Examples 25-27, wherein the (i) K-1 data; and (ii) an K-1 exchange certificate are bundled into a single data file.

Example 29 includes the subject matter of Examples 25-28, wherein the universal data schema further requires one or more attachment files.

Example 30 includes the subject matter of Examples 25-29, wherein the universal data schema requires structured data files with K-1 data including at least: (i) a producer identification; (ii) a recipient identification; (iii) a tax year; (iv) a form type; and/or (v) an issuance type.

Example 31 includes the subject matter of Examples 25-30, wherein the universal data schema requires structured data files with a K-1 exchange certificate including at least: (i) a package identifier that is a unique identifier associated with a structured data file, and (ii) a certification identifier that is a unique identifier indicating that the structured data file has been certified.

Example 32 includes the subject matter of Examples 25-31, wherein the universal data schema includes multiple versions, and the schema validation subsystem is to validate a version of the one or more structured data files.

Example 33 includes the subject matter of Examples 25-32, further comprising instructions for an API gateway to receive one or more structured data files.

Example 34 includes the subject matter of Examples 25-33, wherein there are instructions to require identification of a legal entity as either a K-1 producer or a K-1 receiver to be registered users in the database.

Example 35 includes the subject matter of Examples 25-34, wherein the registration is to enforce a legal entity type, including taxpayer identification number, and contact information for a legal entity account to be created as a registered user in the database.

Example 36 includes the subject matter of Examples 25-35, further comprising instructions to publish one or more structured data files based on one or more connections between one or more K-1 producers and one or more K-1 receivers.

1. A compute device comprising:
circuitry configured to:
establish one or more datastores with a plurality of confidential financial documents;
establish a blockchain-based ledger with a plurality of blocks;
establish matches between one or more producing party and one or more receiving party;
load a smart contract on the blockchain-based ledger in response to receiving a request from the producing party to distribute one or more confidential financial documents of the plurality of confidential financial documents, wherein the smart contract is dynamically generated with programmatic instructions to provide access to the one or more confidential financial documents to be distributed upon verifying the receiving party has satisfied one or more access parameters associated with the one or more confidential financial documents to be distributed; and
triggering a transaction on the blockchain-based ledger, by the receiving party, to execute the smart contract, wherein execution of the smart contract initiates access to the one or more confidential financial documents to be distributed to the requesting party based upon verification of the receiving party's access rights.

2. The compute device of claim 1, further comprising circuitry to dynamically include a hash of the one or more confidential financial documents to be distributed in the smart contract.

3. The compute device of claim 2, wherein the smart contract is to initiate verification of an identity of the receiving party based on zero knowledge proof (ZKP) based authentication process.

4. The compute device of claim 3, wherein to verify the identity of the receiving party through the ZKP-based authentication process comprises to obtain a proof from the receiving party from which the identity of the receiving entity can be verified to a threshold certainty without providing any personally identifiable information (PII) of the requesting party.

5. The compute device of claim 4, wherein the smart contract includes a proof from the producing party from which the identity of the producing party can be verified to a threshold certainty without providing any PII of the producing party.

6. The compute device of claim 1, wherein the smart contract is to create a new block in the blockchain-based ledger indicating access to the one or more confidential financial documents to be distributed.

7. The compute device of claim 6, further comprising circuitry to generate an audit report regarding one or more confidential financial documents to be distributed based on one or more blocks on the blockchain-based ledger.

8. The compute device of claim 7, wherein the one or more blocks in the blockchain-based ledger for the audit report are selected based on the new blocks created as a result of the smart contract.

9. The compute device of claim 1, wherein to establish matches between one or more producing party and one or more receiving party is based on a zero knowledge proof (ZKP) based authentication.

10. The compute device of claim 9, wherein the ZKP based authentication comprises circuitry to:
obtain a request for identity verification of the producing party;
verify the identity of the producing party through a ZK proof received from the producing party from which the identity of the producing party can be verified to a threshold certainty without providing any personally identifiable information (PII) of the producing party;
obtain a request for identity verification of an agent of the producing party;
verify the identity of the agent of the producing party through a ZK proof received from the agent of the producing party from which the identity of the agent of the producing party can be verified to a threshold certainty without providing any personally identifiable information (PII) of the producing party;
validate a request from the producing party to grant authority to the agent of the producing party to release one or more of the confidential documents through one or more ZK proofs received from the producing party;
update permission authority of the producing party to allow release of one or more of the confidential documents by the agent of the producing party.

11. The compute device of claim 10, further comprising circuitry to: (i) obtain a request for identity verification of a receiving party seeking one or more of the confidential financial documents; and (ii) verify the identity of the receiving party through a ZK proof received from the receiving party from which the identity of the receiving party can be verified to a threshold certainty without providing any personally identifiable information (PII) of the receiving party.

12. The compute device of claim 11, further comprising circuitry to: (i) obtain a request for identity verification of an agent of the receiving party; and (ii) verify the identity of the agent of the receiving party through a ZK proof received from the agent of the receiving party from which the identity of the agent of the receiving party can be verified to a threshold certainty without providing any personally identifiable information (PII) of the receiving party.

13. The compute device of claim 12, further comprising circuitry to: (i) validate a request from the receiving party to grant authority to the agent of the receiving party to receive one or more of the confidential documents of the receiving party through one or more ZK proofs received from the receiving party; and (ii) update permission authority of the receiving party to allow one or more of the confidential documents of the receiving party to be received by the agent of the receiving party.

14. The compute device of claim 13, further comprising circuitry to:
receive a request from the receiving party to access one or more of the confidential financial documents of the receiving party;
validate the authority of the agent of the receiving party to access one or more of the confidential financial documents through the ZKP-based authentication;
providing access to one or more of the confidential financial documents of the receiving party in response to validation of the authority of the agent of the receiving party; and
deny access to one or more of the confidential financial documents of the receiving party in response to failure to validate the authority of the agent of the receiving party.

15. The compute device of claim 14, wherein to verify the identity of the producing party through the ZKP-based authentication comprises to obtain a proof from the producing party from which the identity of the producing party can be verified to a threshold certainty without providing any personally identifiable information (PII).

16. The compute device of claim 15, wherein to verify the identity of the producing party through the ZKP-based authentication comprises to obtain a proof from the receiving party from which the identity of the receiving party can be verified to a threshold certainty without providing any personally identifiable information (PII).

17. The compute device of claim 16, wherein the proof from the producing party and/or the proof from the receiving party is a cryptographic artifact.

18. A method comprising:
establishing, by a compute device, one or more datastores with a plurality of confidential financial documents;
establishing, by the compute device, a blockchain-based ledger with a plurality of blocks;
establishing, by the compute device, matches between one or more producing party and one or more receiving party;
loading, by the compute device, a smart contract on the blockchain-based ledger in response to receiving a request from the producing party to distribute one or more confidential financial documents of the plurality of confidential financial documents, wherein the smart contract is dynamically generated with programmatic instructions to provide access to the one or more confidential financial documents to be distributed upon verifying the receiving party has satisfied one or more access parameters associated with the one or more confidential financial documents to be distributed; and
triggering, by the compute device, a transaction on the blockchain-based ledger, by the receiving party, to execute the smart contract, wherein execution of the smart contract initiates access to the one or more confidential financial documents to be distributed to the requesting party based upon verification of the receiving party's access rights.

19. The method of claim 18, dynamically including a hash of the one or more confidential financial documents to be distributed in the smart contract.

20. The method of claim 19, wherein the smart contract is to initiate verification of an identity of the receiving party based on zero knowledge proof (ZKP) based authentication process.
